(19) United States
(12) Patent Application Publication
(10) Pub. No.: US 2026/0144711 A1
(43) Pub. Date: May 28, 2026

(54) SPIKELESS AND NEEDLELESS COUPLINGS FOR LIQUID CONTAINERS

(71) Applicant: Klim-Loc Medical, Inc., Carbondale, CO (US)

(72) Inventor: Robbie Klimek

(73) Assignee: Klim-Loc Medical, Inc., Carbondale, CO (US)

(21) Appl. No.: 19/178,102

(22) Filed: Apr. 14, 2025

Related U.S. Application Data
(63) Continuation of application No. 19/032,213, filed on Jan. 20, 2025.
Application No. 19/032,213 is a continuation of application No. 17/317,455, filed on May 11, 2021, now Pat. No. 12,213,945.
Application No. 17/317,455 is a continuation of application No. 17/111,880, filed on Dec. 4, 2020, now Pat. No. 11,007,120.
Application No. 17/111,880 is a continuation of application No. 16/747,927, filed on Jan. 21, 2020, now abandoned.
Application No. 16/747,927 is a continuation of application No. PCT/US2018/043056, filed on Jul. 20, 2018.
(60) Provisional application No. 62/535,491, filed on Jul. 21, 2017.
(60) Provisional application No. 63/091,986, filed on Oct. 15, 2020.

(51) Int. Cl. A61J 1/20; A61J 1/14

(52) U.S. Cl. CPC A61J 1/2096; A61J 1/1412; A61J 1/2027; A61J 1/2037; A61J 1/2044

(57) ABSTRACT

A fluid reservoir containing liquid contents has a port for fluid removal from the fluid reservoir or injection into the fluid reservoir. The port includes an access member that surrounds a flexible valve. An extraction device has a connecting portion and a hollow tip that are releasably coupled to the access of the access member and valve. When the extraction device is connected to the connection portion, the valve opens and provides access to the liquid contents of the fluid reservoir and when the extraction device is disconnected from the connection portion, the valve member closes and seals the liquid contents in the fluid reservoir.

### CROSS-REFERENCE TO RELATED APPLICATIONS

This application is a continuation in part of U.S. patent application Ser. No. 19/032,213, “Devices And Methods For Needleless And Needled Extraction Of Contents From Vials” filed Jan. 20, 2025, which is a continuation of U.S. patent application Ser. No. 17/317,455, “Devices And Methods For Needleless And Needled Extraction Of Contents From Vials” filed May 11, 2021 now U.S. Pat. No. 12,213,945, which is a continuation of U.S. patent application Ser. No. 17/111,880, “Devices And Methods For Needleless And Needled Extraction Of Contents From Vials”filed Dec. 4, 2020, now U.S. Pat. No. 11,007,120 which claims the benefit of U.S. Provisional Patent Application. No. 63/091,986 , “Devices And Methods For Needleless And Needled Extraction Of Contents From Vials” filed on Oct. 15, 2020. This application also is a continuation in part of U.S. patent application Ser. No. 18/322,381, “Devices And Methods For Needleless Extraction And Administration Of Contents From Vials” filed May 23, 2023, which is a continuation of U.S. patent application Ser. No. 16/744,927, “Devices And Methods For Needleless Extraction And Administration Of Contents From Vials” filed Jan. 16, 2020, now U.S. Pat. No. 11,660,251, which is a continuation of U.S. patent application Ser. No. 16/522,172, “Devices And Methods For Needleless Extraction And Administration Of Contents From Vials” filed Jul. 25, 2019, now U.S. Pat. No. 10,555,871, which is a continuation application of International Application No. PCT/US2018/033085 “Devices And Methods For Needleless Extraction And Administration Of Contents From Vials” filed on May 17, 2018, which claims the benefit of U.S. Provisional Patent Application No. 62/507,575 , “Devices And Methods For Needleless Extraction And Administration Of Contents From Vials” filed on May 17, 2017. The entire contents of each of which are hereby incorporated by reference in their entirety.

### BACKGROUND

In the medical field, intravenous (IV) solutions are sterile fluids that are injected into a vein to treat or prevent dehydration, or to treat other conditions. IV fluids can be stored in IV bags. The IV solutions can be used to treat dehydration, regain vitality, and treat conditions like diabetes. IV solutions can be drawn from a liquid container such as an IV bag using a hollow spike that is part of a drip assembly. The spike is manually plunged into a penetrable cap of an IV bag to allow for extraction of the IV liquid from the IV bag into an IV line. A needle or canula can be placed on an end of IV line and inserted into a patient. The IV liquid can pass from the IV bag through the IV line and into the patient. The assembly of the spike to the liquid container is time consuming, and the extraction/administration process is subject to risks associated with handling a sharp spike. Mishandling of the spike can lead to unintentional needle punctures to people or surrounding objects. What is needed is an improved IV drip to liquid container coupling that does not include a spike or other sharp components.

### BRIEF DESCRIPTION OF THE DRAWINGS

FIG. 1 illustrates an exploded view of an IV fluid reservoir assembly according to at least one example embodiment.

FIG. 2 illustrates an assembled perspective view of the IV fluid reservoir assembly of FIG. 1 according to at least one example embodiment.

FIG. 3 illustrates an assembled top view of the IV fluid reservoir assembly in FIG. 1 according to at least one example embodiment.

FIG. 4 illustrates a cross-sectional view of the IV fluid reservoir assembly in FIG. 3 along the line according to at least one example embodiment.

FIG. 5 illustrates side view of a valve member of the IV fluid reservoir assembly according to at least one example embodiment.

FIG. 6 illustrates a cross-sectional view of the valve member in FIG. 5 along the line 6-6 according to at least one example embodiment.

FIG. 7 illustrates a side view of an access member of the IV fluid reservoir assembly according to at least one example embodiment.

FIG. 8 illustrates a cross-sectional view of the access member according to at least one example embodiment.

FIG. 9 illustrates a package including the syringe and the IV fluid reservoir outlet according to at least one example embodiment.

FIG. 10 illustrates a method of manufacturing the IV fluid reservoir assembly according to at least one example embodiment.

FIG. 11 illustrates an exploded view of an IV fluid reservoir assembly coupling according to at least one example embodiment as well as various cross-sectional and top views for certain elements of the IV fluid reservoir assembly.

FIG. 12A illustrates a side perspective view of the IV fluid reservoir assembly coupling according to at least one example embodiment.

FIG. 12B illustrate a top of the IV fluid reservoir assembly coupling according to at least one example embodiment.

FIG. 12C illustrate a cross section side view of the IV fluid reservoir assembly coupling according to at least one example embodiment.

FIG. 13A illustrates a side view of the valve member according to at least one example embodiment.

FIG. 13B illustrates a side cross section view of the valve member according to at least one example embodiment.

FIG. 13C illustrates a bottom view of the valve member according to at least one example embodiment.

FIG. 13D illustrates a side view of the access member according to at least one example embodiment.

FIG. 13E illustrates a side cross section view of the access member according to at least one example embodiment.

FIG. 13F illustrates a bottom view of the access member according to at least one example embodiment.

FIG. 14A illustrates a bottom perspective view of the access member according to at least one example embodiment.

FIG. 14B illustrates a bottom perspective view of the valve member according to at least one example embodiment.

FIG. 14C illustrates a bottom perspective view of the assembled access member and valve member according to at least one example embodiment.

FIG. 14D illustrates a bottom perspective view of the assembled access member and valve member according to at least one example embodiment.

FIG. 14E illustrates a top perspective view of the assembled access member and valve member according to at least one example embodiment.

FIG. 14F illustrates a see-through bottom perspective view of the assembled access member and valve member according to at least one example embodiment.

FIG. 15A illustrates a perspective view of an IV fluid reservoir assembly according to at least one example embodiment.

FIG. 15B illustrates a cross-sectional view of an IV fluid reservoir assembly according to at least one example embodiment.

FIG. 16A illustrates a top perspective view of an IV fluid reservoir assembly according to at least one example embodiment.

FIG. 16B illustrates an exploded view of an IV fluid reservoir assembly according to at least one example embodiment.

FIG. 16C illustrates a cross-sectional view of an IV fluid reservoir assembly according to at least one example embodiment.

FIG. 17A illustrates a perspective view of an IV fluid reservoir assembly according to at least one example embodiment.

FIG. 17B illustrates an exploded view of an IV fluid reservoir assembly according to at least one example embodiment.

FIG. 17C illustrates a cross-sectional view of an IV fluid reservoir assembly according to at least one example embodiment.

FIGS. 18A-18D illustrate side views of embodiments of IV fluid reservoir assemblies having inlet ports and outlet ports.

FIG. 19A illustrates an embodiment of an IV fluid bag reservoir with an IV drip in a disassembled state.

FIG. 19B illustrates an embodiment of an IV fluid bag reservoir with an IV drip in an assembled state.

FIG. 20A illustrates an embodiment of an IV fluid bag reservoir with an IV drip in a disassembled state.

FIG. 20B illustrates an embodiment of an IV fluid bag reservoir with an IV drip in an assembled state.

FIG. 21A illustrates a perspective view of a syringe with a needleless connector.

FIG. 21B illustrates a front view of a syringe with a needleless connector.

FIG. 21C illustrates a side view of a syringe with a needleless connector.

FIG. 22A illustrates an embodiment of an IV fluid bag reservoir prior to coupling with an IV drip.

FIG. 22B illustrates an embodiment of an IV fluid bag reservoir coupled with an IV drip.

FIG. 22C illustrates an embodiment of an IV fluid bag reservoir prior to coupling with a syringe.

FIG. 22D illustrates an embodiment of an IV fluid bag reservoir coupled with a syringe.

FIG. 23A illustrates an embodiment of an IV drip assembly having a spike connector.

FIG. 23B illustrates an embodiment of an IV drip assembly having a spikeless connector.

FIG. 24 illustrates an embodiment of an IV bag and line assembly.

FIG. 25 illustrates cross section views of an IV bag connector, a connection adapter, and a vial connector in a disassembled state.

FIG. 26 illustrates cross section views of an IV bag connector, a connection adapter, and a vial connector in an assembled state.

### DETAILED DESCRIPTION

Example embodiments include a fluid coupling assembly including an intravenous (IV) fluid reservoir such as an IV bag and a cap assembly coupled to the IV fluid reservoir. The fluid coupling assembly can eliminate the need for using a sharp object such as a spike or needle for both the extraction of contents from the IV fluid reservoir and the administration of contents to the IV fluid reservoir. The cap assembly includes a valve, a seal or sealing member, an access member, and a hollow housing. The valve and the sealing member may be comprised of a flexible sealing material, such as silicone, rubber, or other elastomer material. The access member may be comprised of a polymer or other plastic-type material and serves as an access port between the valve and the IV fluid reservoir. The hollow housing may be comprised of aluminum (e.g., as an aluminum crimp), other bendable metal or other suitable material that fastens the valve, the seal, and the access member to the IV fluid reservoir.

The valve may be a hollow, unitary member that includes two integrated cylindrical portions (top and bottom) that appear concentric from a top view. The valve includes a slit in a top surface that seals the IV fluids in the reservoir in the closed position and allows liquids to flow through the valve and out of the IV fluid reservoir into an IV line assembly in the open position. The valve can be closed when an extraction device is not coupled to the fluid coupling assembly and the valve can be opened when an extraction device is not coupled to the fluid coupling assembly. The valve may be comprised of silicone or another flexible material, such as rubber.

In some embodiments, the fluid coupling assembly can include two cap assemblies coupled to the IV fluid reservoir. One cap assembly can allow IV fluids to flow out of the IV fluid reservoir into an extraction device that can be part of an IV line assembly. The second cap assembly can allow fluids to be injected into the IV fluid reservoir. The valves of the cap assemblies can be closed while the IV fluid reservoir is in storage sealing the IV fluids in the IV fluid reservoir.

The IV line assembly can include an extraction device that includes a connection portion, a tip, drip chamber, an air vent, a filter, and a line connection. The line connection can be coupled to an IV line tubing that delivers the IV fluids to a Luer lock that is attached to a cannula or needle that is inserted into a patient. Various other components can be attached to the IV line tubing including a back check valve, a port for connecting a secondary IV line tubing, a clamp such as a slider clam or a roller clamp. When connection portion of the IV line assembly extraction device is attached to the cap assembly on the IV fluid reservoir, the tip can compress and open the valve within the access member. The IV fluids can flow through the IV line tubing into the patient and the flow rate of the IV fluids can be controlled with the drip chamber and clamps.

When fluids need to be added to the IV fluid reservoir, an injection device such as a syringe or vial can be coupled to the second cap assembly on an additive port on the IV fluid reservoir. The injection device can have a connection portion and tip. In some embodiments, the injection device can be a syringe having a hollow holding portion, a plunger, a connection portion, and a tip. A liquid medication can be stored in the hollow holding portion. The connection portion can be coupled to the second cap assembly. When the connection portion is attached to the second cap assembly on the IV fluid reservoir, the tip can compress and open the valve within the access member of the second cap assembly on an additive port. The plunger can be actuated and the liquid medication fluids can flow from the injection device through the open the valve within the access member and into the IV fluid reservoir. Once the liquid medication fluids are injected, the connection portion can be detached from the second cap assembly and the valve can close sealing the liquids in the IV fluid reservoir.

In other embodiments, the injection device can be a vial that is coupled to a connection portion, and a tip. When the connection portion is attached to the second cap assembly on the IV fluid reservoir, the tip can compress and open the valve within the access member of the second cap assembly on an additive port. The vial and the IV fluid reservoir can be inverted or turned upside down so that the vial is above the IV fluid reservoir and liquid medication fluids can flow from the vial through the open the valve within the access member and into the IV fluid reservoir. Once the liquid medication fluids are injected into the IV fluid reservoir, the connection portion can be detached from the second cap assembly and the valve can close sealing the liquids in the IV fluid reservoir.

The access member includes a first (top) section and a second (bottom) section. Both sections may be substantially cylindrical from a top view. The first section includes a connection portion that protrudes from a top of the cap assembly and allows for connection to a syringe. For example, the connection portion may include a male thread engagement for connection to a corresponding female thread engagement on the syringe. The connection portion defines a cavity which, when assembled, fits the top portion of the valve so that the valve slit is visible on a surface of the valve that faces away from the IV fluid reservoir. The second section also defines the cavity so that, when assembled, the second section fits the bottom portion of the valve. The second section includes an opening to allow for access to the liquid in the IV fluid reservoir. The first section and the second section of the access member may be separable from one another at a separation point to allow for installation of the valve into the cavities of the first and second sections. After installation of the valve, the first and second sections may be bonded together by, for example, an adhesive (e.g., glue, an ultraviolet (UV) curable adhesive, a heat curable adhesive, etc.).

The seal or sealing member seals a space between the access member and the IV fluid reservoir. The seal may comprise silicone or any other material capable of creating an airtight seal. The seal may be an O-ring seal. Although the seal is shown as being separate from the access member and the IV fluid reservoir, it should be understood that the seal may be integrated with or adhered to at least one of the IV fluid reservoir and the access member if desired.

The hollow housing may be comprised of a sheet metal, such as aluminum or other suitable material. Although the housing is shown in a crimped state with ends at each opening being bent over, it should be understood that the housing's initial state can be a cylindrical piece of sheet metal that fits over a top of the cap assembly and IV fluid reservoir before being crimped on both ends to attach (e.g., permanently attach) the cap assembly to the IV fluid reservoir.

The valve may be insertable into the access member so as to be housed within the access member so that the opening in the bottom section of the access member is aligned with the hollow portion of the valve to allow for extraction of liquid from the IV fluid reservoir. For extraction, a user attaches an IV fluid extraction device to the male threaded engagement of the access member that protrudes from the cap assembly coupled to the IV fluid reservoir. Here, the IV fluid extraction device has a corresponding female threaded engagement on an inner surface of one end of the IV fluid extraction device that surrounds a hollow protrusion having a blunt tip that leads to an IV drip structure. The hollow protrusion and the female threaded engagement are arranged such that, when the IV fluid extraction device is screwed onto the cap assembly, the blunt tip of the hollow protrusion pushes (or compresses) the valve toward the liquid in the IV fluid reservoir, which causes the slit in the valve to expand, open, and allow the liquid to flow from the IV fluid reservoir through the opening in the access member, the valve, and the hollow protrusion and into the drip section of the IV fluid extraction device. In one example, the hollow protrusion extends beyond the female threaded engagement so that the protrusion makes the initial contact with the valve. Here, the valve is flexible enough so that the user can push the valve down with protrusion and simultaneously screw the syringe to the cap assembly. The tip of the hollow protrusion can also form a seal against the elastomer material of the valve adjacent and surrounding the slit.

An example IV fluid extraction device may include the hollow protrusion, the female thread on an inner surface of a cylindrical connection portion, and the IV drip section. The outer surface of the hollow protrusion can be tapered or cylindrical. The distal end of the tip of the hollow protrusion can have a planar annular tip surface. The outer diameter of the planar annular tip surface is wider than the length of the slit in the valve. In some embodiments, the inner diameter of the planar annular tip surface is wider than the length of the slit in the valve. When the planar annular tip surface compresses the valve, a liquid tight seal can be formed between the planar annular tip surface and the valve to prevent liquids from leaking from the coupling.

The inventive IV fluid extraction device is an improvement over prior art IV drip devices that include a sharp hollow spike. These prior require a user to push the sharp hollow spike through a port in an IV bag. The sharp spike can easily result in injury to a user or damage due to improperly puncturing the port in the IV bag. In contrast to sharp structures, the inventive system provides a needless or spikeless administration of the fluid to the IV fluid extraction device and the IV line. Thus, the IV fluid extraction drip device may have an access port that utilizes the same technology as the valve, the access member, the seal and the housing as described in U.S. Pat. No. 11,007,120 which is hereby incorporated by reference. Alternatively, the drip (or whatever device is intended to receive the now extracted liquid) may employ an assembly that has the same or similar technology as the valve and the access member, but have a different means of sealing/securing the access member/valve to the drip.

In view of the above, it should be appreciated that example embodiments mitigate (or alternatively, eliminate) the disadvantages and risks of conventional devices that require assembly of a spike on an IV drip or a needle to a syringe for both extraction and administration of medicine from an IV fluid reservoir. For example, the cap assembly according to example embodiments reduces the time required to assemble a device that can extract liquid from an IV fluid reservoir since a spike does not need to be inserted into a port and/or a needle does not have to be affixed to a separate syringe. Example embodiments also reduce (or alternatively eliminate) the risks associated with using a needle/syringe combination to extract and administer medicine to a patient.

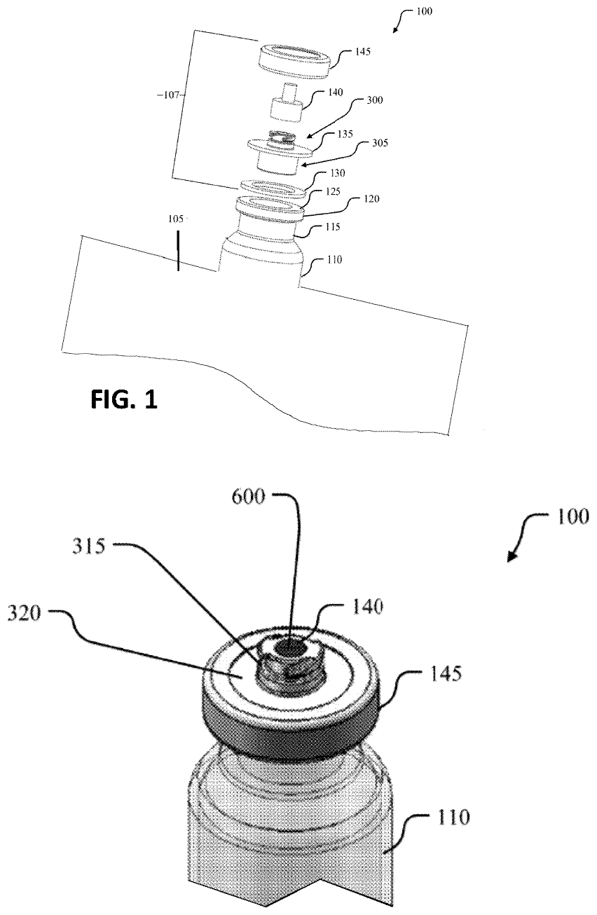

FIG. 1 illustrates an exploded view of an IV fluid reservoir assembly 100 according to at least one example embodiment. As shown in FIG. 1, the IV fluid reservoir assembly 100 includes an IV fluid reservoir 105 for holding contents (e.g., liquid contents) and a cap assembly 107 that can eliminate the need for using a needle or a spike for both the extraction of contents from the IV fluid reservoir 105 and administration of medicine into the IV fluid reservoir 105. The access portion of the IV fluid reservoir 105 includes a body portion 110, a neck portion, and a rim portion 120 having a planar upper surface 125. The body portion 110 can be coupled to an end of the IV fluid reservoir 105

The cap assembly 107 includes a seal or sealing member 130, an access member 135, a valve or valve member 140, and a housing 145. The valve 140 and the sealing member 130 may be comprised of a flexible sealing material, such as silicone. The access member 135 may include sections 300 and 305 and be comprised of a polymer or other plastic-type material and serves as an access port between the valve 140 and the IV fluid reservoir 105. The hollow housing 145 may be comprised of aluminum (e.g., as an aluminum crimp), other bendable metal that is capable of being crimped, or other suitable materials. The details of each element in FIG. 1 are described in more detail below with reference to FIGS. 2-10.

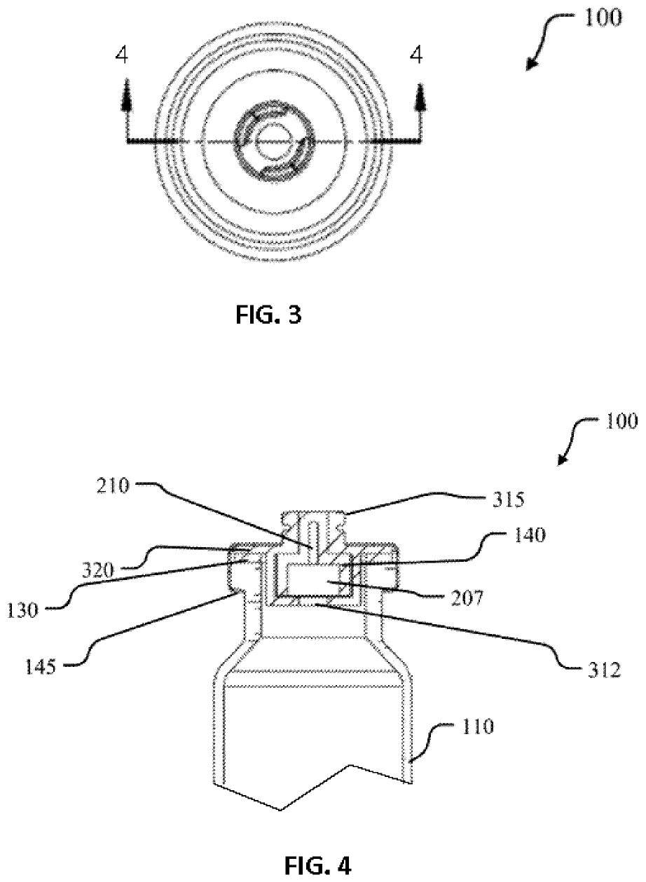

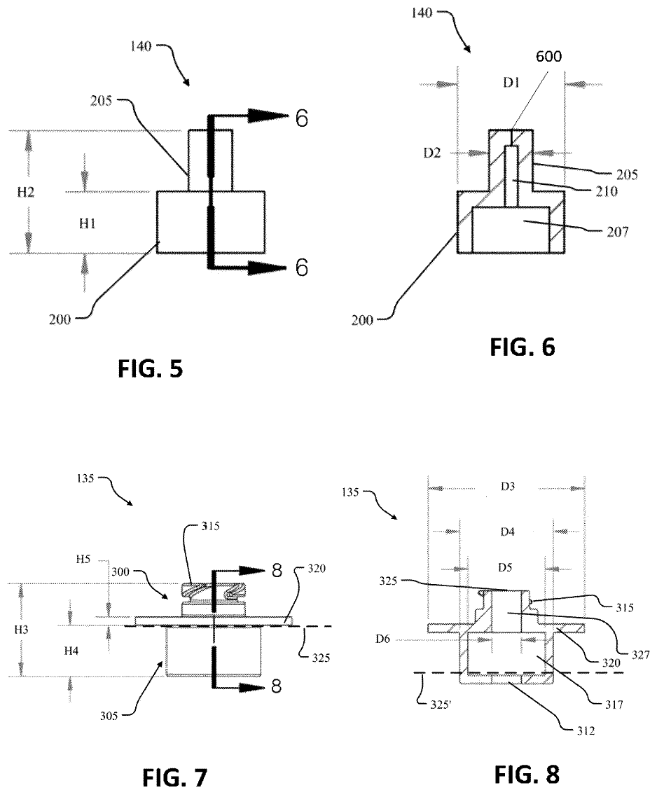

FIG. 2 illustrates an assembled perspective view of the IV fluid reservoir assembly 100 of FIG. 1 according to at least one example embodiment. FIG. 3A illustrates an assembled top view of the IV fluid reservoir assembly 100 in FIGS. 1 and 2 according to at least one example embodiment. FIG. 3B illustrates a cross-sectional view of the IV fluid reservoir assembly 100 in FIG. 3A along the line according to at least one example embodiment. FIG. 4A illustrates side view of a valve 140 of the IV fluid reservoir assembly 100 in FIG. 1 according to at least one example embodiment. FIG. 4B illustrates a cross-sectional view of the valve 140 in FIG. 4A along the line IV-IV′ according to at least one example embodiment. FIG. 5A illustrates a side view of an access member 135 of the IV fluid reservoir assembly 100 in FIG. 1 according to at least one example embodiment. FIG. 5B illustrates a cross-sectional view of the access member 135 in FIG. 5A along the line V-V′ according to at least one example embodiment. FIG. 6A illustrates a side view of a sealing member 130 of the IV fluid reservoir assembly 100 in FIG. 1 according to at least one example embodiment. FIG. 6B illustrates a top view of the sealing member 130 in FIG. 6A according to at least one example embodiment. FIG. 7A illustrates a side view of a housing 145 of the IV fluid reservoir assembly in FIG. 1 according to at least one example embodiment. FIG. 7B illustrates a cross-section view of the housing 145 in FIG. 7A along the line VII-VII′ according to at least one example embodiment.

As shown in FIG. 2, by way of crimping the housing 145, the remainder of the cap assembly 107 is fixable to the IV fluid reservoir 105. For example, the housing 145 slides over the valve 140, the sealing member 130, and the access member 135, and the rim portion 120 before being crimped around the access member 135 and the rim portion 120 to fasten the cap assembly 107 to the IV fluid reservoir 105.

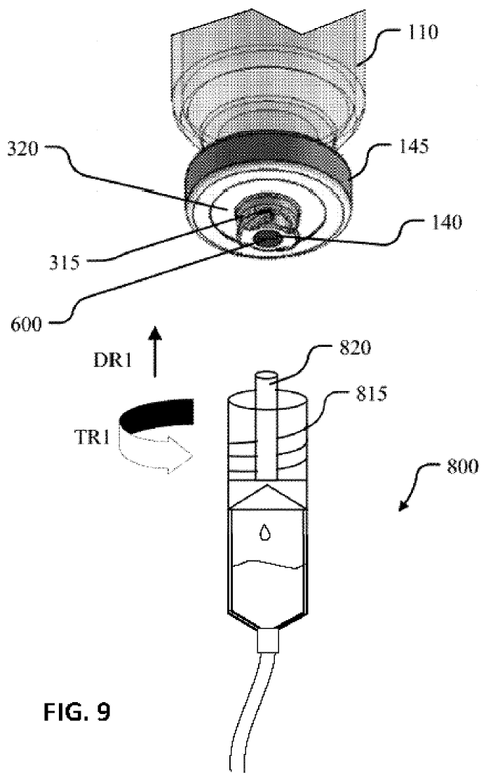

With reference to FIGS. 1-7B, the cap assembly 107 may include the access member 135 including a first section 300 and a second section 305 (see FIGS. 1, 5A, and 5B). The first section 300 includes a connection portion 315 that is attachable to an extraction device (e.g., a syringe 800 as in FIGS. 8A-9) that extracts (or inserts) contents of the reservoir 105. As shown in FIGS. 3B, 5A and 5B, the connection portion 315 includes a first opening 325, and the second section 305 includes a second opening 312 in fluid communication with the contents of the reservoir 105 when the access member 135 is secured to the reservoir 105. As also shown in FIGS. 5A and 5B, the connection portion 315 may protrude from the access member 135 and include a male connector, such as a male connector with an outer thread for a screw connection to a corresponding female connector with an inner thread (see FIGS. 8A and 8B).

As shown in FIGS. 1-3B, the valve member 140 is insertable into the access member so as to be housed within the access member so that the opening 312 in the second section 305 of the access member 135 is aligned with the hollow portions 207/210 of the valve 140 to allow for extraction of contents from the IV fluid reservoir 105. As shown in FIG. 2, the valve member 140 may include a top portion with a slit 600, which is located in the first opening 325 of the connection portion 315 when the cap assembly 107 is fixed to the IV fluid reservoir 105. According to at least one example embodiment, the valve member 140 is comprised of a flexible material, such as silicone, so that the valve member 140 is compressible relative to the first opening 325. Here, it should be appreciated that the slit 600, in an uncompressed state of the valve member 140, is closed and seals the contents of the reservoir 105 at the first opening 325 when the connection portion 315 is not attached to the extraction device. Additionally, the slit 600, in a compressed state of the valve member 140, opens and provides the access to the contents of the reservoir 105 when the connection portion 315 is attached the extraction device (e.g., syringe 800 in FIGS. 8A and 8B). Upon attachment of the connection portion 315 to the extraction device, contents of the reservoir 105 are ready to be extracted. In other words, the valve member 140 is insertable into the access member 135 so as to be housed in the access member 135 and in fluid communication with the first opening 325 and the second opening 315 and such that the valve member 140 i) seals the contents of the reservoir 105 at the first opening 325 when the connection portion 315 is not attached the extraction device (e.g., syringe 800 in FIG. 9), and ii) provides access to the contents of the reservoir 105 through the first opening 325 when the connection portion 315 is attached to the extraction device.

As shown in FIGS. 4A and 4B, the valve member 140 may have a first section 205 and a second section 200. The first section 205 and the second section 200 are substantially cylindrical shaped. The first section 205 includes a first hollow portion 210 and the second section 200 includes a second hollow portion 207. As shown in FIGS. 3A and 3B, the hollow portions 207/210 are in fluid communication with the reservoir 105 through the opening 312 in the access member 135. In addition, the hollow portion 210 is fluid communication with the slit 600 in FIG. 2 to allow for extraction of the contents from the reservoir 105. The first section 200 may have a height H1 of about 0.200 in, and a diameter D1 of about 0.350 in. The first and second sections 205 and 200 may have a total height H2 of about 0.400 in. The second section 200 may have a diameter D2 of about 0.143 in.

As shown in FIGS. 5A and 5B, the access member 135 includes the first section 300 and the second section 305. In order to allow the valve member 140 to be inserted into the access member 135 (as shown in FIGS. 2 and 3B), the access member 135 may be physically cut into the first section 300 and the second section 305, for example, along the line 325. Alternatively, sections 300 and 305 are manufactured as separate pieces. In any event, after the valve member 140 is inserted into the one of the sections 300/305, the sections 300 and 305 are adhered to one another, for example, by ultraviolet (UV) curing, heat curing, or other suitable adhesive technique. In other words, the first section 300 and the second section 305 are detachably connected. Thus, according to at least one example embodiment, the sections 300 and 305 comprise a UV or heat curable material. Although FIG. 5A shows that the sections 300 and 305 are separated along the line 325, it should be appreciated that other separation locations may be used according to design and/or manufacturing preferences. For example, FIG. 5B shows another example separation location along the line 325′. The first section 300 may include a planar portion 320 that is designed to rest on the sealing member 130 and be supported by the rim portion 125 of the IV fluid reservoir 105. As shown in FIGS. 3B and 5B, the access member 135 includes hollow portions 317 and 327 to accommodate the valve member 140.

As shown in FIGS. 5A and 5B, the access member 135 has a total height H3 of about 0.445 in., the second section 305 has a height H4 of about 0.246 in, and the planar portion 320 has a height H5 of about 0.039 in. In addition, a diameter D3 of the access member 135 is about 0.750 in., a diameter D4 of the second section 305 is about 0.450 in., a diameter D5 of the hollow portion 317 is about 0.371 in, and a diameter D6 of the openings 312 and 325 is about 0.143 in.

As shown in FIGS. 6A and 6B, a height H6 of the sealing member 130 may be about 0.040 in., an outer diameter D6 of the sealing member 130 is about 0.750 in, and an inner diameter D7 of the sealing member 130 is about 0.500 in. With reference to FIGS. 1 and 3B, it should be appreciated that the sealing member 130 seals an interface between the reservoir 105 (e.g., the planar surface 125) and the planar portion 320 of the access member 135. The sealing member 130 may be comprised of a flexible sealing material, such as rubber, silicone, or other suitable sealing material. Although the sealing member 130 is shown as an element separate from the IV fluid reservoir 105, it should be understood that the sealing member 130 may also be integrated with the IV fluid reservoir 105, for example, via a pre-existing attachment to the planar surface 125 of the rim portion 120.

FIGS. 7A and 7B illustrate additional details of the housing 145. As noted above, the housing 145, secures the access member 135 and the sealing member 130 to the reservoir 105. According to at least one example embodiment, the housing 145 is a bendable and hollow cylinder with openings at each end. To secure the access member 135 and the sealing member 130 to the IV fluid reservoir 105, the housing 145 slides over the remainder of the cap assembly 107 and the rim portion 125. Then, both ends of the housing 145 are bent (or crimped) toward a center of the housing 145 to fix the cap assembly 107 to the IV fluid reservoir 105. According to at least one example embodiment, the housing is a metal, such as aluminum.

As shown in FIGS. 7A and 7B, a final, assembled, height H7 of the housing 145 may be about 0.211 in., while an initial, pre-assembled, height H8 of the housing 145 may be about 0.231 in. Here, the initial height H8 refers to a height of the housing prior to attachment of the cap assembly 107 to the IV fluid reservoir 105, i.e., prior to the ends of the housing 145 being bent toward the center of the housing 145 to secure the access member 135 and the sealing member 130 to the IV fluid reservoir as shown in FIG. 2. In addition, the final height H7 refers to a height of the housing 145 after attachment of the cap assembly 107 to the IV fluid reservoir 105, i.e., after bending the ends of the housing 145 toward the center to secure the access member 135 and the sealing member 130 to the IV fluid reservoir 105 as shown in FIG. 2. An outer diameter D8 of the housing 145 may be about 0.787 in., an intermediate diameter D9 of the housing 145 may be about 0.700 in., and an inner diameter D10 of the housing 145 may be about 0.570 in.

FIG. 8A illustrates a perspective view of a syringe 800 according to at least one example embodiment. FIG. 8B illustrates a cross-sectional view of the syringe 800 in FIG. 8B along the line VIII-VIII′ according to at least one example embodiment.

As shown in FIGS. 8A and 8B, the syringe 800 includes a hollow holding portion 805, a plunger 810, a connection portion 815, and a tip 820. The connection portion 815 may include a female thread for engagement with the male thread of the connection portion 315. The tip 820 may protrude beyond an upper surface of the connection portion 815 in order to allow for the tip 820 to penetrate the connection portion 315 when connecting the syringe 800 to the IV fluid reservoir assembly 100, thereby compressing the valve member 140.

FIG. 9 illustrates a package 900 including the syringe 800 in FIGS. 8A and 8B and the IV fluid reservoir assembly 100 of FIGS. 1-7B according to at least one example embodiment. FIG. 9 illustrates an example of the syringe (or extraction device) 800 being moved in a direction DR1 toward the IV fluid reservoir assembly 100 such that the tip 820 penetrates the connection portion 315 to thereby compress the valve member 140 and open the slit 600 to provide access to the contents of the IV fluid reservoir 105. As the tip 820 compresses the valve member 140, the syringe 800 may be twisted in the clockwise direction TR1 in order to engage the female thread on the connection portion 815 with the male thread on the connection portion 315. Now, the syringe 800 and the IV fluid reservoir assembly 100 are attached to one another in a manner that allows the contents of the IV fluid reservoir to be extracted or inserted by, for example, actuation of the plunger 810. In order to release the syringe 800 from the IV fluid reservoir assembly 100, the syringe 800 may be twisted in the counter-clockwise direction to disengage the female thread of the connection portion 815 from the male thread of the connection portion 315.

In view of FIGS. 1-9, it should be understood that the valve member 140 is insertable into the access member 135 so as to be housed in the access member 135 and in fluid communication with the first opening 325 and the second opening 315 such that the valve member 140 i) seals the contents of the reservoir 105 at the first opening 325 when the connection portion 315 is not attached the extraction device 800, and ii) provides access to the contents of the reservoir 105 through the first opening 325 when the connection portion 315 is attached to the extraction device 800. Here, it should be appreciated that the slit 600, in an uncompressed state of the valve member 140, seals the contents of the reservoir 105 at the first opening 325 when the connection portion 315 is not attached to the extraction device 800. Additionally, the slit 600, in a compressed state of the valve member 140, provides the access to the contents of the reservoir 105 when the connection portion 315 is attached the extraction device (e.g., syringe 800 in FIG. 9). Upon attachment of the connection portion 315 to the extraction device 800, contents of the reservoir 105 are ready to be extracted.

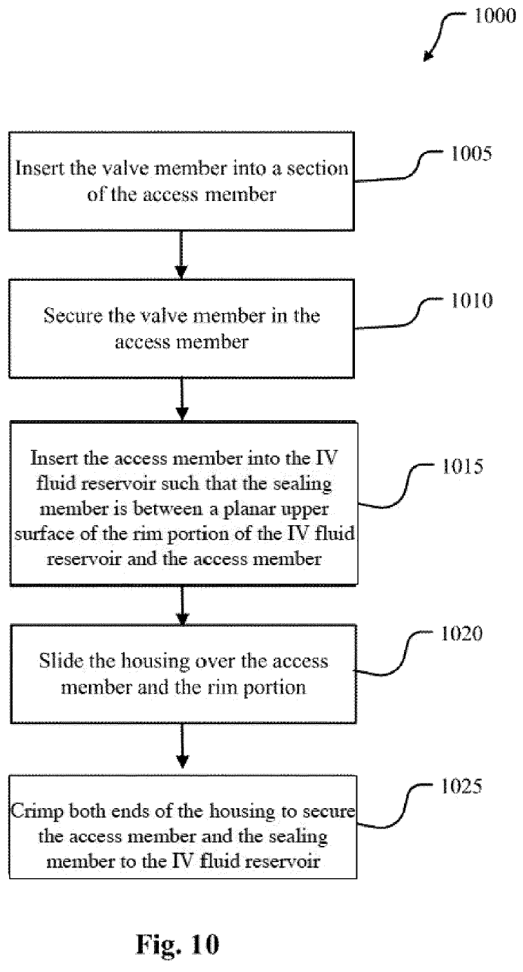

FIG. 10 illustrates a method 1000 of manufacturing the IV fluid reservoir assembly 100 in FIGS. 1-7B according to at least one example embodiment.

While a general order for the steps of the method 1000 is shown in FIG. 10, the method 1000 can include more or fewer steps or can arrange the order of the steps differently than those shown in FIG. 10 if desired. Hereinafter, the FIG. 10 shall be explained with reference to the systems, components, assemblies, devices, user interfaces, environments, software, etc. described in conjunction with FIGS. 1-9.

In operation 1005, the method 1000 includes inserting the valve member 140 into a section of the access member 135. As noted above, the access member 135 is split into sections, for example, sections 300/305 to allow for insertion of the valve member 140.

In operation 1010, the method 1000 includes securing the valve member 140 in the access member 135, for example, by adhering section 300 to section 305 using a suitable adherent and/or adhering process.

In operation 1015, the method 1000 includes inserting the access member 135 into the IV fluid reservoir 105 (e.g., the neck 115) such that the sealing member 130 is between the planar upper surface 125 of the rim portion 120 and the access member 135 (e.g., a bottom surface of the planar portion 320).

In operation 1020, the method 1000 includes sliding the housing 145 over the access member 135 and the rim portion 120.

In operation 1025, the method 1000 includes crimping (or bending) both ends of the housing 145 to secure the access member 135 and the sealing member 130 to the IV fluid reservoir 105. For example, one end of the housing 145 is bent toward a central axis of the IV fluid reservoir 105 in order to make contact with an upper surface of the planar portion 320. The other end of the housing is bent toward the central axis of the IV fluid reservoir 105 so as to make contact with a bottom surface of the rim portion 120. Now, cap assembly (including the sealing member 130, the access member 135, the valve member 140, and the housing 145 are secured to the IV fluid reservoir 105 to complete the IV fluid reservoir assembly 100.

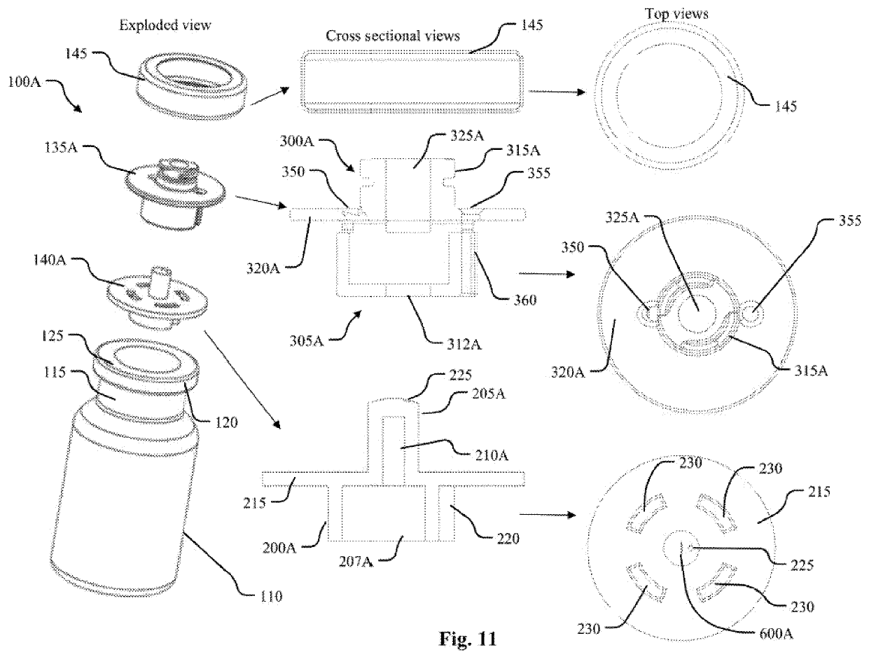

FIGS. 11-17 illustrate various views of IV fluid reservoir assemblies according to additional example embodiments. FIGS. 11-17 include some of the same elements referenced above in the description of FIGS. 1-10. Accordingly, these elements include the same numbering in FIGS. 11-17 as in FIGS. 1-10 and a description of these elements will not be repeated.

FIG. 11 illustrates an exploded view of an IV fluid reservoir assembly 100A according to at least one example embodiment as well as various cross-sectional and top views for certain elements of the IV fluid reservoir assembly 100A.

As in FIGS. 1-10, the IV fluid reservoir assembly 100A includes a housing 145 and a female Luer or access member 135A. Compared to FIGS. 1-10, the valve member and sealing member or septum are integrated with one another as valve member 140A (or integrated valve and sealing member), thereby reducing the number of individual parts compared to FIGS. 1-10. Similar to FIGS. 1-10, the access member 135A and the valve member 140A are fixed to the IV fluid reservoir 105 with the housing 145 (e.g., aluminum or other bendable material).

FIG. 11 illustrates an example where the access member 135A includes a first port (or connection portion) 315A that enables needleless extraction as in FIGS. 1-10 through opening 325A and at least one second port that enables needled extraction of the contents from the IV fluid reservoir 105. FIG. 11 shows two second ports 350 and 355 that enable needled extraction of contents from the IV fluid reservoir 105. The ports 350 and/or 355 may be useful if, for example, the port 315A is damaged or otherwise unusable to extract contents from the IV fluid reservoir 105.

As shown, the access member 135A includes a planar portion 320A and a first portion 300 A including port 315A that protrudes from a first side of the planar portion 320A. The port 315A is attachable to a needleless extraction device (e.g., device 800 from FIG. 8). For example, as in FIGS. 1-10, the first portion 300A of port 315A includes threading that engages with corresponding threading on a needleless extraction device. The access member 135A includes a second portion 305A that protrudes from a second side of the planar portion 320A opposite the first side. The second portion 305A includes a groove 360.

The ports 350 and 355 comprise respective openings in the planar portion 320A of the access member 135A. As shown, the opening for port 350 may be formed in the planar portion 320A to have angled sidewalls. The angle of the sidewalls may correspond to an angle that guides a needle toward the contents of the IV fluid reservoir 105 through opening 312A of the access member 135A. On the other hand, the opening for port 355 may be formed in the planar portion 320A to have substantially straight sidewalls. As shown in FIG. 11, the port 355 is aligned with the groove 360 in the access member 135A. The groove 360 serves as a guide to guide a needle attached to a syringe to the contents of the IV fluid reservoir 105. The groove 360 is shown as extending in a direction substantially perpendicular to the planar portion 320A but the groove 360 may also be formed to angle inward or outward away from or toward a central vertical axis of the IV fluid reservoir 105.

The access member 135A may be formed of molded plastic or other suitable material. The ports 350 and 355 are shown as being formed on opposite sides of the access member 135A and at a base of port 315A, but example embodiments are not limited thereto and the ports 350 and 355 may be formed at other locations on the planar portion 320A. Although not explicitly shown, it should be appreciated that if the housing 145 extends all the way to the base of the port 315A, then the housing 145 may also include openings aligned with ports 350 and 355.

The valve member 140A includes a first section 200A that protrudes from a planar portion 215, and a second section 205A that protrudes from an opposite side of the planar portion 215. As in FIGS. 1-10, the valve member 140A includes hollow sections 210A and 207A that fit into corresponding hollow sections of the access member 135A. The valve member 140A further includes a groove 220 to match the groove 360 of the access member 135A. When assembled, the groove 220 is at an interior of the access member 135A.

In at least one example embodiment, the valve member 140A is positioned in or configured to be positioned in the access member 135A to i) enable needleless extraction of the contents of the reservoir 105 or injection of medicine into the reservoir 105 through the first port 315A when the first port 315A is attached to a needleless extraction device 820, ii) enable needled extraction of the contents or injection of medicine into the reservoir 105 through the at least one second port 350 and/or 355, and iii) seal the contents of the reservoir 105 at the first port 315A and at the at least one second port 350 and/or 355 prior to and subsequent to the needleless or needled extraction or injection of medicine into the reservoir 105 (e.g., seal the contents at all times other than during extraction). When assembled, small portions of the valve member 140A are exposed by the ports 350 and 355. Thus, as in FIGS. 1-10, the valve member 140A is formed of a material (e.g., silicone) that allows a needle to pass through the material to the contents of the IV fluid reservoir 105 while still sealing the contents upon removal of the needle.

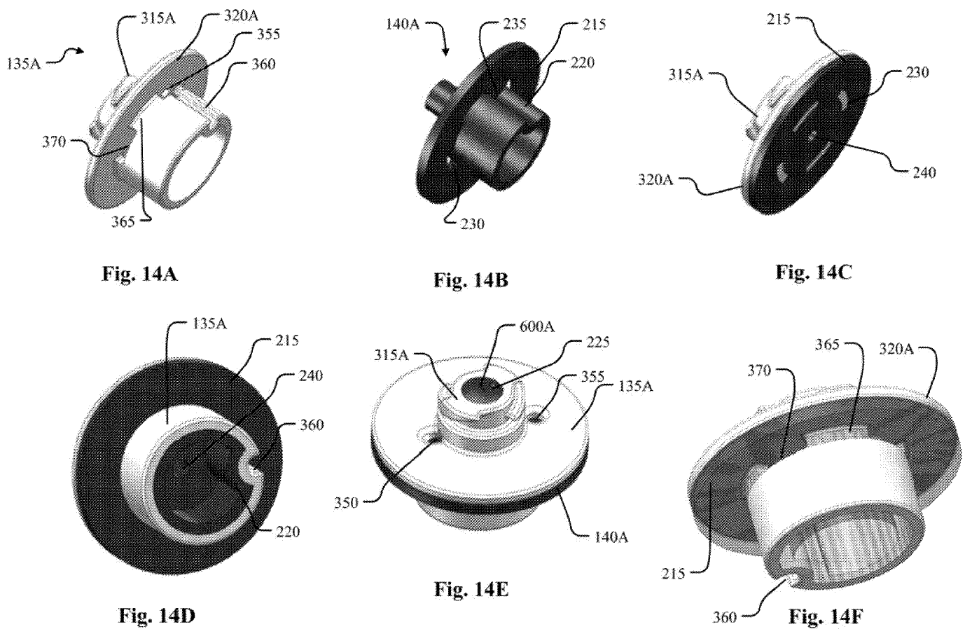

Here, it should be appreciated that although FIG. 11 illustrates that the valve member 140A is separate from the access member 135A, it should be appreciated that the valve member 140A may be formed by an over molding process in which a material of the valve member 140A is over molded onto the access member 135A (see FIGS. 14A to 14F for more detail).

As further shown in FIG. 11, the valve member 140A includes a slit 600A, a dimple 225 to further assist with needled extraction through a tip of the valve member 140A if desired, and openings 230 in the planar portion 215. The openings 230 are formed as a result of the over molding process mentioned above in that the access member 135A includes pillars (not depicted in FIG. 11) around which the material of the valve member 140A is formed to create the openings 230. Although four openings 230 are shown, more or fewer openings may be included as desired.

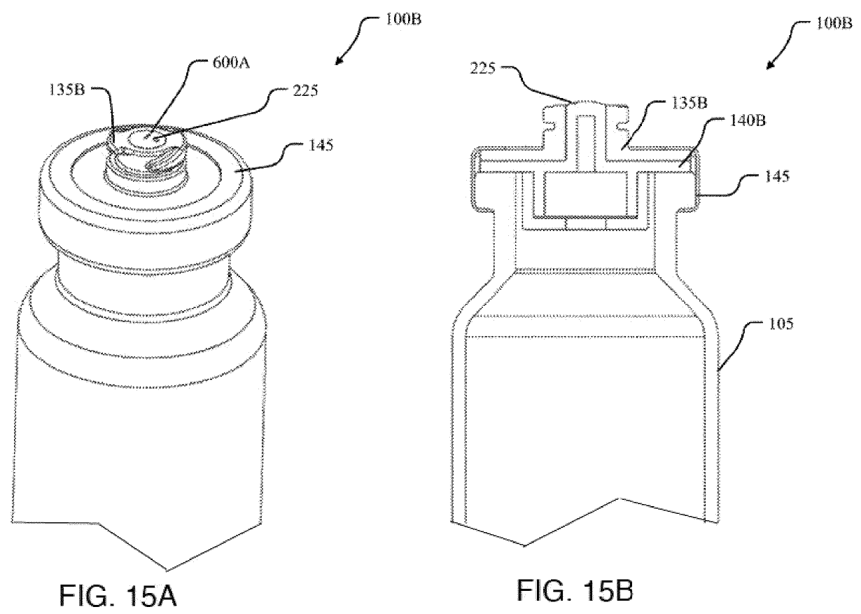

Here, it should be appreciated that FIG. 11 illustrates views for an IV fluid reservoir assembly having the same needleless extraction or injection capabilities as described above with reference to FIGS. 1-10 with the addition of three possible “backup” ports that allow for extraction of the contents or injection of medicine using a needle: a dimple 225 on the valve member 140A to assist with needle insertion, a straight needle port 355 that guides a needle to the contents in substantially a straight line, and an angled needle port 350 that guides a needle to the contents at an angle. However, it should be appreciated that there may be more or fewer than the three ports for needle extraction or needle injection. For example, there may be zero dedicated ports for needle extraction or needle injection similar FIGS. 1-10. In this case, the ports 350 and 355 and the grooves 220 and 360 are omitted (see FIG. 15 for such an example where the dimple 225 would be removed in addition to the ports 350 and 355).

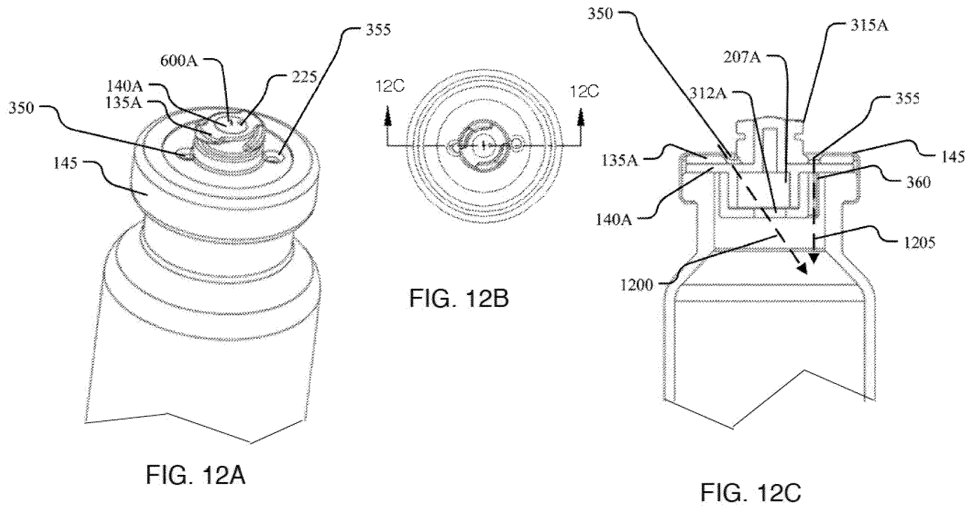

FIGS. 12A, 12B, and 12C illustrate various assembled views for the IV fluid reservoir assembly 100A of FIG. 11. In more detail, FIG. 12A illustrates a perspective view, FIG. 12B illustrates a top view, and FIG. 12C illustrates a cross-sectional view taken along line XII-XII′ of the top view. As shown in FIGS. 12A, 12B, and 12C, when fully assembled, portions of the valve member 140A are exposed by the ports 315A, 350, and 355 to allow for needleless and needled extraction of contents from the IV fluid reservoir 105 or injection of medicine contents into the IV fluid reservoir 105. As noted above, the port 350 can have angled sidewalls to assist with directing a needle along path 1200 to contents of the IV fluid reservoir 105. The angle of the sidewalls may be designed such that the needle is guided through opening 312A in the access member 135A. The port 355 is aligned with groove 360 to guide a needle along path 1205 to the contents of the IV fluid reservoir 105. As further shown, the housing 145 secures the access member 135A and the valve member 140A to the IV fluid reservoir 105 in the same or similar manner as the housing from FIGS. 1-10. In FIGS. 12A, 12B, and 12C, an outer edge of the planar portion 320A of the access member 135A is sandwiched between the housing 145 and an outer edge of the planar portion 215 of the valve member 140A to effectively seal the contents of the IV fluid reservoir 105.

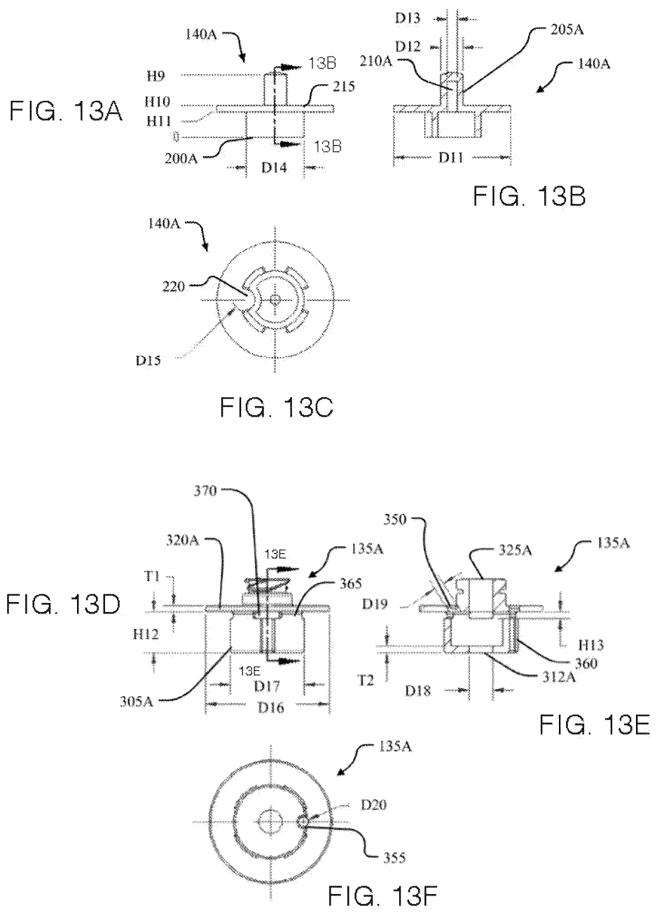

FIGS. 13A-13F illustrate example dimensions for the access member 135A and the valve member 140A in FIGS. 11 and 12 according to at least one example embodiment. FIG. 13A illustrates a side view of the access member 135A. FIG. 13B illustrates a cross-sectional view of the access member 135A. FIG. 13C illustrates a top view of the access member 135A. FIG. 13D illustrates a side view of the valve member 140A. FIG. 13E illustrates a cross-sectional view of the valve member 140A. FIG. 13F illustrates a top view of the valve member 140A. In FIG. 13B the cross-sectional view in for the valve member 140A is taken along line XIII-XIII′ shown in FIG. 13A while in FIG. 13E the cross-sectional view for the access member 135A is taken along line XIV-XIV′ shown in FIG. 13D.

A diameter D11 of planar portion 215 of the valve member 140A may be about 0.750 in or between 0.500 in and 1.000 in. The section 205A has a diameter D12 of about 0.143 in or between 0.100 in and 0.200 in. while the hollow section 210A has a diameter D13 of about 0.063 in or between 0.020 in and 0.100 in. A total height H9 of the valve member 140A is about 0.400 in or between 0.200 in and 0.600 in. A height H10 from a bottom of the valve member 140A to a top of the planar portion 215 is about 0.200 in or between 0.100 in and 0.300 in. while a height H11 from a bottom of the valve member 140A to a bottom of the planar portion 215 is about 0.160 in or between 0.050 in and 0.250 in. A diameter D14 of the section 200 is about 0.0371 in or between 0.020 in and 0.060 in. As further shown, a diameter D16 of the groove 220 is about 0.070 in or between 0.040 in and 0.100 in.

Turning to the access member 135A, a diameter of the planar portion 320A is about 0.750 in or between 0.500 in and 0.100 in and a diameter D17 of section 305A is about 0.450 in or between 0.200 in and 0.700 in. A height H12 of the section 305A is about 0.246 in or between 0.100 in and 0.400 in. while a thickness T1 of the planar portion 320A is about 0.039 in or between 0.020 in and 0.060 in. Although not explicitly shown, a total height of the access member 135A may be slightly more than the total height of the valve member 140A in order to accommodate the valve member 140A. Diameters D18 of the openings 312A and 325A are about 0.143 in or between 0.050 in and 0.300 in. while a diameter D19 of the port 350 is about 0.060 in or between 0.030 in and 0.100 in. A diameter D20 of the port 355 may also be about 0.060 in or between 0.030 in and 0.100 in. A thickness T2 of the portion of the access member 135A that creates the opening 312A is about 0.039 in or between 0.020 in and 0.060 in. and a height H13 of a pillar 365 and corresponding opening 370 is about 0.040 in or between 0.020 in and 0.060 in.

Here, it should be appreciated that the dimensions of the housing 145 in FIGS. 11 and 12 are substantially the same as the dimensions of the housing described with reference to FIGS. 1-10.

FIGS. 14A-14F illustrate various assembled and unassembled views of the access member 135A and the valve member 140A in FIGS. 11-13 according to at least one example embodiment. In more detail, FIG. 14A illustrates a view of the access member 135A, FIG. 14B illustrates a view of the valve member 140A, and FIGS. 14C-14F illustrate various assembled views for the access member 135A and the valve member 140A (noting that FIG. 14C does not illustrate bottom portions of the access member 135A and the valve member 140A for the sake of explanation).

FIG. 14A illustrates a bottom perspective view of the access member 135A to show that the access member 135A includes pillars 365 and openings 370. The pillars 365 and openings 370 may facilitate an over molding process where a material of the valve member 140A is over molded onto the access member 140A. In this case, the material of the valve member 140A is formed in the openings 370 while the pillars 365 create corresponding openings 230 in the valve member 140A. In the example of FIG. 14A, the access member 135A includes four pillars 365 and four openings 370, but more or fewer pillars and openings may be included if desired.

FIG. 14B illustrates a bottom perspective view of the valve member 140A separated from the access member 135A. In the event that the valve member 140A is formed with an over molding process, it should be appreciated that views showing the valve member 140A separated from the access member 135A is for the purposes of illustration only, and does not necessarily suggest that valve member 140A is designed to be removable from the access member 135A after the over molding process is complete. In any event, FIG. 14B shows that the planar portion 215 includes the openings 230 and the groove 220. As further shown, a portion 235 of the planar portion 215 is located at a top of the groove 220 to enable needled extraction of the contents and to seal the contents at all other times.

FIG. 14C illustrates a bottom perspective view of the assembled access member 135A and valve member 140A (also referred to as a cap assembly with or without the inclusion of the housing 145) without showing bottom portions of the access member 135A and the valve member 140A to emphasize the existence of opening 240 through which the contents of the IV fluid reservoir may be extracted via the port 315A. As shown, the planar portions 215 and 320A abut one another so that when fixed to the IV fluid reservoir 105 by the housing 145 leakage of the contents at the rim of the IV fluid reservoir 105 is prevented.

FIG. 14D illustrates a bottom perspective view of the assembled access member 135A and valve member 140A while showing bottom portions of the access member 135A and the valve member 140A. As shown, the groove 220 form fits to a back side of groove 360. As may be appreciated, the pillars 365 and openings 370 are not visible because the valve member 140A is formed in the openings 370 to surround the pillars 365.

FIG. 14E illustrates a top perspective view of the assembled access member 135A and valve member 140A. FIG. 14E illustrates how portions of the valve member 140A are exposed by the ports 350 and 355 to enable needled extraction. As shown, outer edges of the planar portion 320A and the planar portion 215 are substantially flush with one another.

FIG. 14F illustrates a see-through bottom perspective view of the assembled access member 135A and valve member 140A in order to show how the planar portion 215 of the valve member 140A covers the pillars 365 and openings 370 of the access member 135A.

FIG. 15A illustrates a perspective view and FIG. 15B illustrates a cross-sectional view of an IV fluid reservoir assembly 100B according to at least one example embodiment. The IV fluid reservoir assembly 100B includes a body 105, an access member 135B, a valve member 140B, and a housing 145. FIGS. 15A and 15B illustrate an example IV fluid reservoir assembly having only the dimple 225 to assist with needled extraction of the contents from the IV fluid reservoir 105. Thus, the access member 135B is different than the access member 135A in that the access member 135B does not include openings for ports 350 and 355 and does not include groove 360. The valve member 140B is different than the valve member 140A in that valve member 140B does not include groove 220. The access member 135B and valve member 140B may still include all other remaining structures (e.g., openings and pillars) shown for access member 135A and valve member 140A to enable the same over molding process described above.

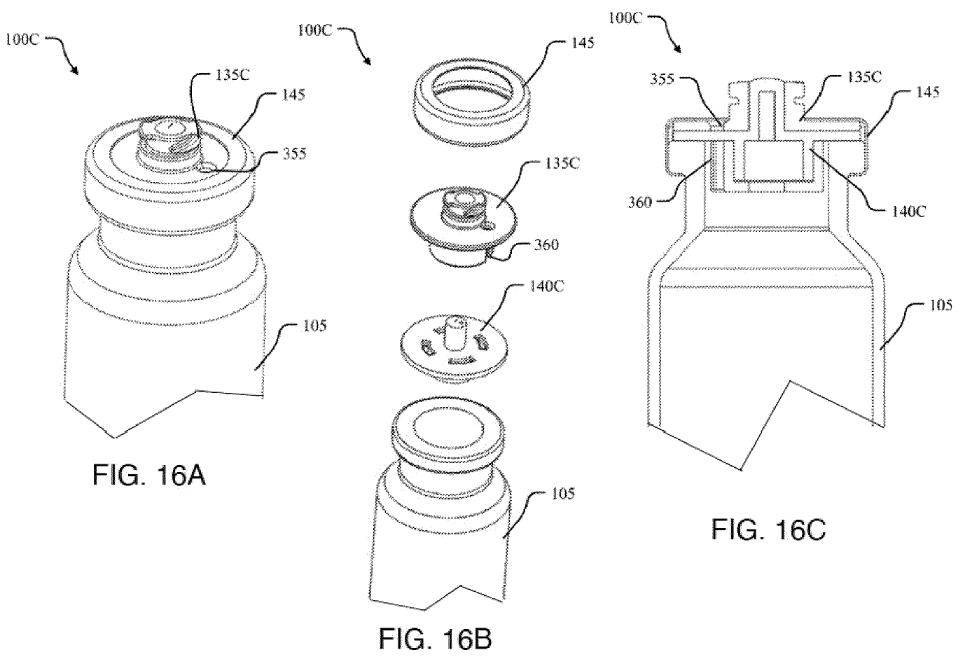

FIG. 16 illustrates a perspective view, an exploded view, and a cross-sectional view of an IV fluid reservoir assembly 100C according to at least one example embodiment. The IV fluid reservoir assembly 100C includes a body 105, an access member 135C, a valve member 140C, and housing 145. The IV fluid reservoir assembly 100C includes a single port 355 for needled extraction of the contents in the same manner as that described above with reference to FIGS. 11-14. Accordingly, the access member 135C includes the groove 360 and the valve member 140C includes the groove 220. The access member 135C and valve member 140C may still include all other remaining structures (e.g., openings and pillars) shown for access member 135A and valve member 140A to enable the same over molding process described above.

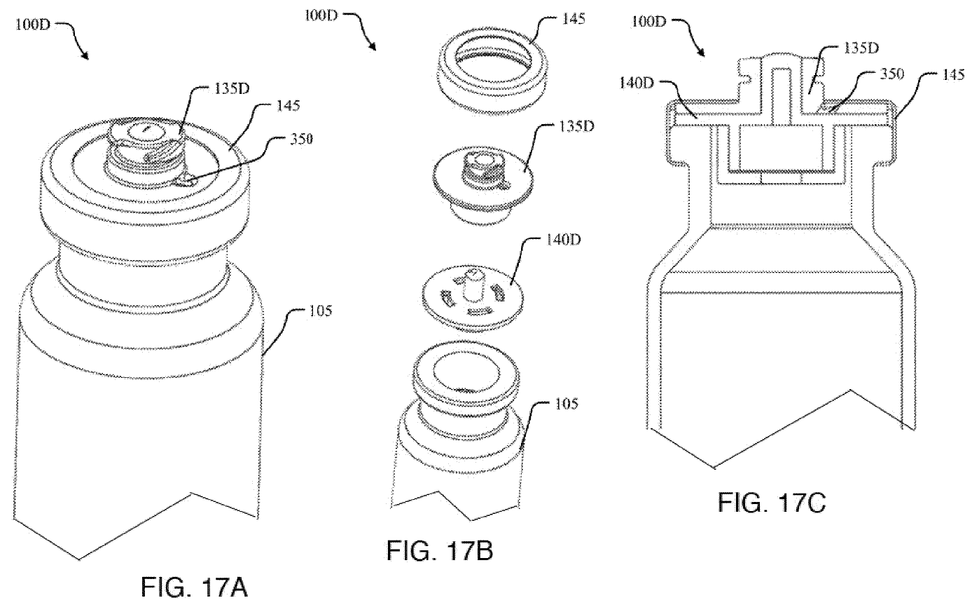

FIG. 17 illustrates a perspective view, an exploded view, and a cross-sectional view of an IV fluid reservoir assembly 100D according to at least one example embodiment. The IV fluid reservoir assembly 100D includes a body 105, an access member 135D, a valve member 140D, and housing 145. The IV fluid reservoir assembly 100D includes a single port 350 for needled extraction of the contents in the same manner as that described above with reference to FIGS. 11-14. Accordingly, the grooves 360 and 220 in the access member 135D and the valve member 140D may be omitted. The access member 135D and valve member 140D may still include all other remaining structures (e.g., openings and pillars) shown for access member 135A and valve member 140A to enable the same over molding process described above.

FIGS. 11-17 illustrate examples where a valve member is over molded onto an access member. However, example embodiments are not limited thereto and other methods of forming the assembled valve member and access member are possible. For example, the valve member may be formed by a mold process to have the structure shown in FIG. 14B and then fitted onto the access member. In this case, the bottom of the access member may include protrusions (not shown) that correspond to the four openings 230 in the member, which allow the valve member to be slid onto the access member by inserting the protrusions into the openings 230 of the valve member.

In view of the above, it should be appreciated that example embodiments illustrated in FIGS. 1-10 may be modified to include the dimple, the straight needle port, the angled needled port, or any combination thereof if desired. In this case, the structure of the access member 135 in FIGS. 1-10 may be modified to look the same or similar to the access member of FIGS. 11-17 to include the port 350 and/or the port 355. For example, such port(s) of access member 135 in FIGS. 1-10 may be sealed by the valve member 140 so long as such port(s) is formed on the access member 135 in an area that overlaps the valve member 140. For a port 355, the groove 360 may be moved to an interior of the access member 135. For a port 350, the angled sidewalls of the access member may be angled to help guide a needle through the opening in the access member 140 and valve member 135. It should further be appreciated that the IV fluid reservoir assemblies shown in FIGS. 11-17 are assembled in the same manner as in FIGS. 1-10 except that an over molding process may be performed to seat the valve member into the access member prior to crimping these elements to the IV fluid reservoir with the housing.

For needless administration of the fluid in the syringe, an IV line or drip can have a port that employs the same or similar concepts as those described above with respect to the cap assembly. For example, drip may have an access port that utilizes the same technology as the valve, the access member, the seal and the housing. Alternatively, the drip (or whatever device is intended to receive the now extracted liquid) may employ an assembly that has the same or similar technology as the valve and the access member, but have a different means of sealing/securing the access member/valve to the drip.

At least one example embodiment includes a cap assembly including an access member including a first section and a second section, the first section including a connection portion that is attachable to an extraction device that extracts contents of a reservoir, the connection portion including a first opening, the second section including a second opening in fluid communication with the contents of the reservoir when the access member is secured to the reservoir. The cap assembly includes a valve member insertable into the access member and in fluid communication with the first opening and the second opening and such that the valve member i) seals the contents of the reservoir at the first opening when the connection portion is not attached the extraction device, and ii) provides access to the contents of the reservoir through the first opening when the connection portion is attached to the extraction device.

According to at least one example embodiment, the cap assembly includes a sealing member to seal an interface between the reservoir and the access member, and a housing that secures the access member and the sealing member to the reservoir.

According to at least one example embodiment, the housing is a bendable and hollow cylinder, and wherein ends of the housing are bent toward a center of the cylinder to secure the access member and the sealing member to the reservoir.

According to at least one example embodiment, the housing is a metal.

According to at least one example embodiment, the valve member is a flexible material.

According to at least one example embodiment, the valve member is compressible and includes a top portion with a slit located in the first opening of the connection portion when the valve member is inserted into the access member.

According to at least one example embodiment, the slit, in an uncompressed state of the valve member, seals the contents of the reservoir at the first opening when the connection portion is not attached to the extraction device. The slit, in a compressed state of the valve member, provides the access to the contents of the reservoir when the connection portion is attached the extraction device.

According to at least one example embodiment, the first section and the second section are detachably connected.

According to at least one example embodiment, the connection portion protrudes from the access member and includes a male thread to engage with a female thread of the extraction device.

At least one example embodiment includes an IV fluid reservoir assembly including a reservoir to hold contents, and a cap assembly fixable to the reservoir. The cap assembly includes an access member including a first section and a second section, the first section including a connection portion that is attachable to an extraction device that extracts the contents from the reservoir, the connection portion including a first opening, the second section including a second opening in fluid communication with the contents of the reservoir when the access member is secured to the reservoir. The cap assembly includes a valve member insertable into the access member and in fluid communication with the first opening and the second opening and such that the valve member i) seals the contents of the reservoir at the first opening when the connection portion is not attached the extraction device, and ii) provides access to the contents of the reservoir through the first opening when the connection portion is attached to the extraction device.

At least one example embodiment includes a package including a reservoir to hold contents, an extraction device to at least one of extract or insert the contents, a cap assembly fixable to the reservoir. The cap assembly includes an access member including a first section and a second section, the first section including a connection portion that is attachable to the extraction device that extracts contents of the reservoir, the connection portion including a first opening, the second section including a second opening in fluid communication with the contents of the reservoir when the access member is secured to the reservoir. The cap assembly includes a valve member insertable into the access member and in fluid communication with the first opening and the second opening and such that the valve member i) seals the contents of the reservoir at the first opening when the connection portion is not attached the extraction device, and ii) provides access to the contents of the reservoir through the first opening when the connection portion is attached to the extraction device.

In view of the above, it should be appreciated that example embodiments mitigate (or alternatively, eliminate) the disadvantages and risks of conventional devices that involve assembly of a needle to a syringe for insertion/extraction and administration of medicine from an IV fluid reservoir. For example, a cap assembly according to example embodiments reduces the time required to assemble a device that can extract liquid from an IV fluid reservoir since a needle does not have to be affixed to a separate syringe. Example embodiments also reduce (or alternatively eliminate) the risks associated with using a needle/syringe combination to extract and administer medicine to a patient.

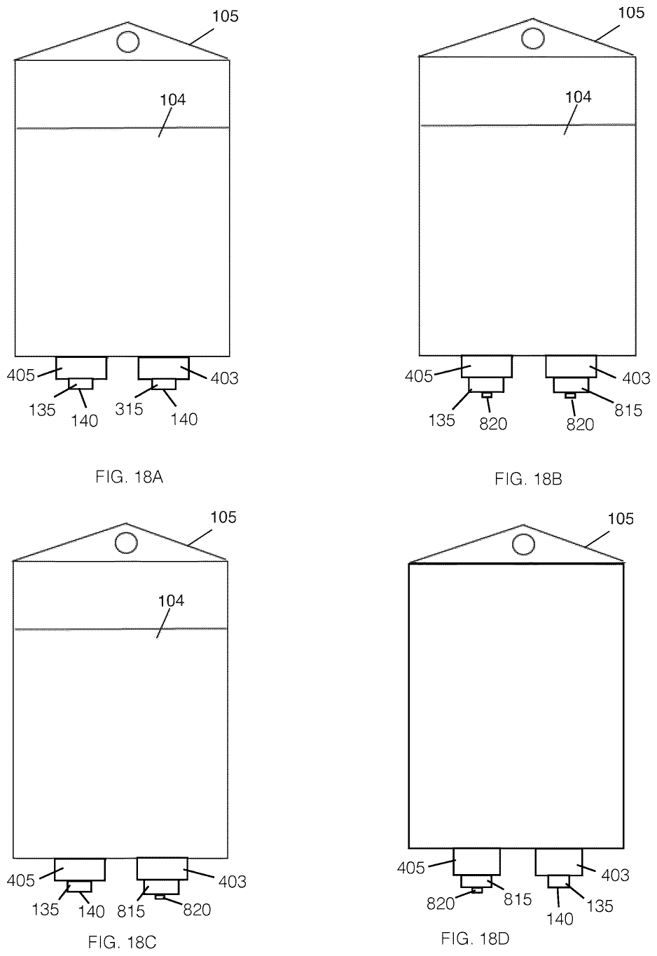

FIGS. 18A-18D illustrate side views of embodiments of IV fluid bag reservoirs 105 storing IV fluids 104 with different combinations of inlet and outlet connection ports that have been described above. FIG. 18A illustrates an embodiment of IV fluid bag reservoir 105 having an inlet port 403 and an outlet port 405 that are both access members 135 that surround valves 140. FIG. 18B illustrates an embodiment of IV fluid bag reservoir 105 having an inlet port 403 and an outlet port 405 that both have cylindrical connection portions 815 that surround a center hollow tip 820. FIG. 18C illustrates an embodiment of IV fluid bag reservoir 105 having an inlet port 403 that has a cylindrical connection portion 815 that surround a center hollow tip 820 and an outlet port 405 that includes an access member 135 that surrounds a valve 140. FIG. 18D illustrates an embodiment of IV fluid bag reservoir 105 having an inlet port 403 that includes an access member 135 that surrounds a valve 140 and an outlet port 405 that has a cylindrical connection portion 815 that surround a center hollow tip 820.

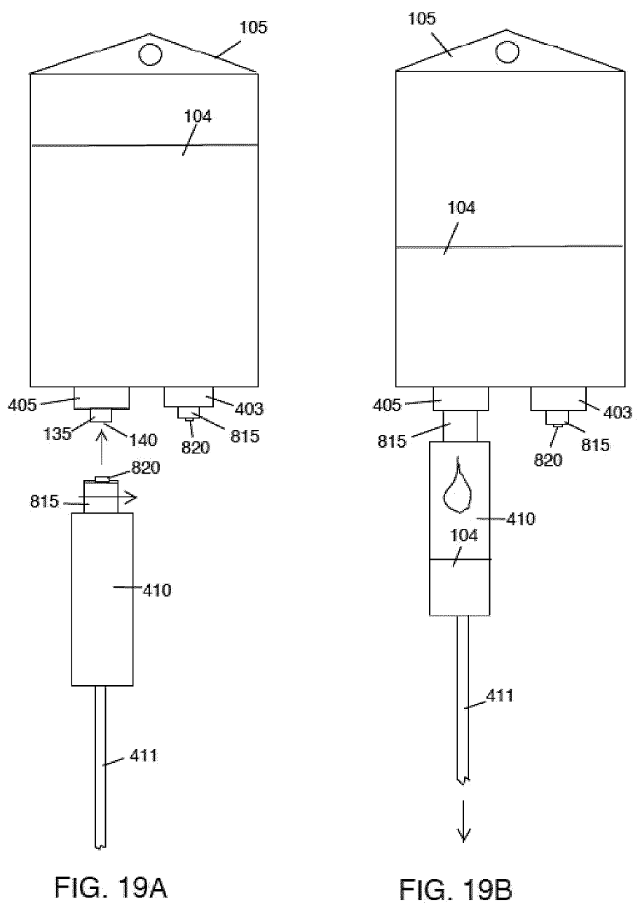

With reference to FIGS. 19A and 19B when a patient is in need of IV fluids, an IV fluid reservoir can be an IV bag reservoir 105 that can be attached to an IV drip 410 coupled to an IV line 420. The IV bag reservoir 105 can have an inlet port 403 having a connection portion 815 surrounding a hollow tip 820 and an outlet port 405 that can have a valve 140 within an access member 135. The valves 140 can have a slit on the on the tip that is normally in a closed seal position to keep the IV fluid 104 in the IV bag reservoir 105. The IV drip 410 can have an inlet that has a cylindrical connection portion 815 and a hollow tip 820 that are constructed and function in substantially the same manner described above. The cylindrical connection portion 815 can have female threads on the inner cylindrical diameter surface that surround a hollow tip 820.

In FIG. 19A, the connection portion 815 is moved into alignment with the access members 135. When the connection portion 815 is moved into connect with the access members 135 the hollow tip 820 is pressed against valve 140. The internal threads of the cylindrical connection portion 815 can engage features extending from the outer diameter of the access member 135. The hollow tip 820 compresses valve 140 and causes the slit to open and the end of the hollow tip 820 forms a seal with the end of the valve 140 to prevent the IV fluid 104 from leaking from the connection. FIG. 19B illustrates the connection portion 815 fully coupled to the access member 135 with IV fluid 104 flowing through the outlet port 405 into the IV drip 140. Drips of the IV fluid 104 flow downward to the opposite end of the IV drip 140 and into the IV line 411.

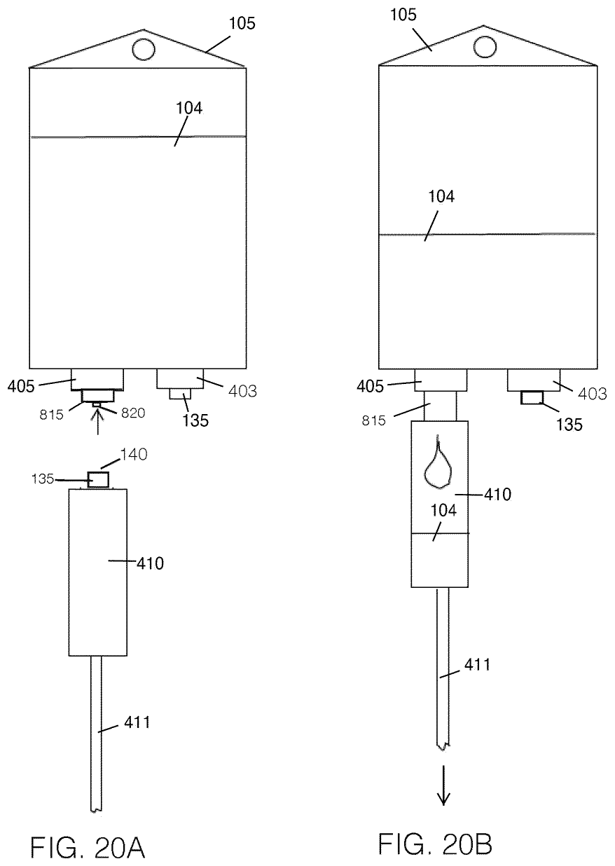

FIGS. 20A and 20B are similar to FIGS. 19A and 19B respectively. However, in FIGS. 20A and 20B the IV bag reservoir 105 can have an inlet port 403 that can have a valve 140 within an access member 135 and an outlet port 405 having a connection portion 815 surrounding a hollow tip 820. The IV drip 410 can have an inlet that has a valve 140 within an access member 135.

In FIG. 20A, the connection portion 815 is moved into alignment with the access members 135. The internal threads of the cylindrical connection portion 815 engage features extending from the outer diameter of the access member 135. The hollow tip 820 compresses valve 140 and causes the slit to open and the end of the hollow tip 820 forms a seal with the end of valve 140 to prevent the IV fluid 104 from leaking from the connection. FIG. 20B illustrates the connection portion 815 fully coupled to the access member 135 with IV fluid 104 flowing through the outlet port 405 into the IV drip 140. Drips of the IV fluid 104 flow downward to the opposite end of the IV drip 140 and into the IV line 411.

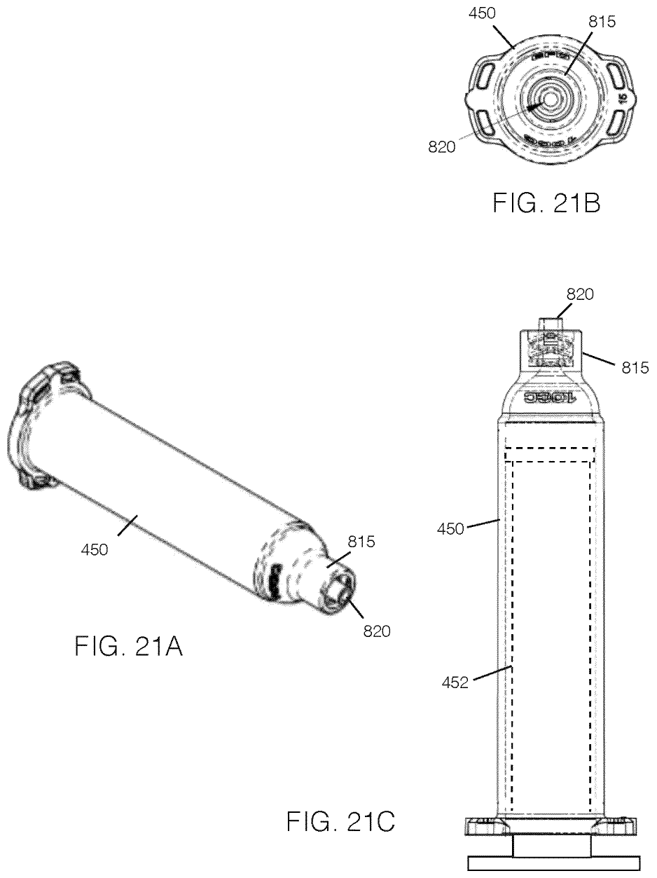

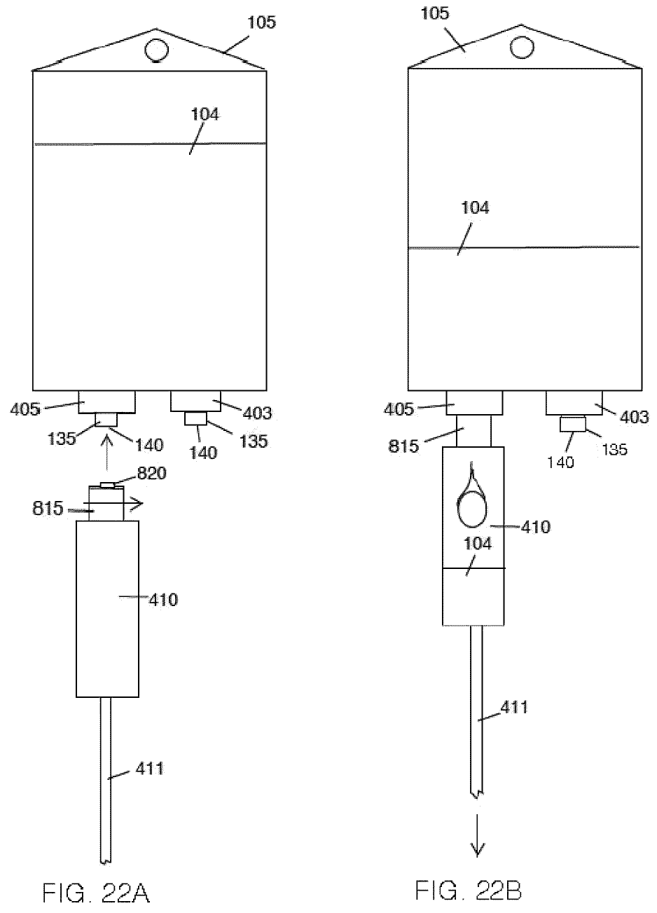

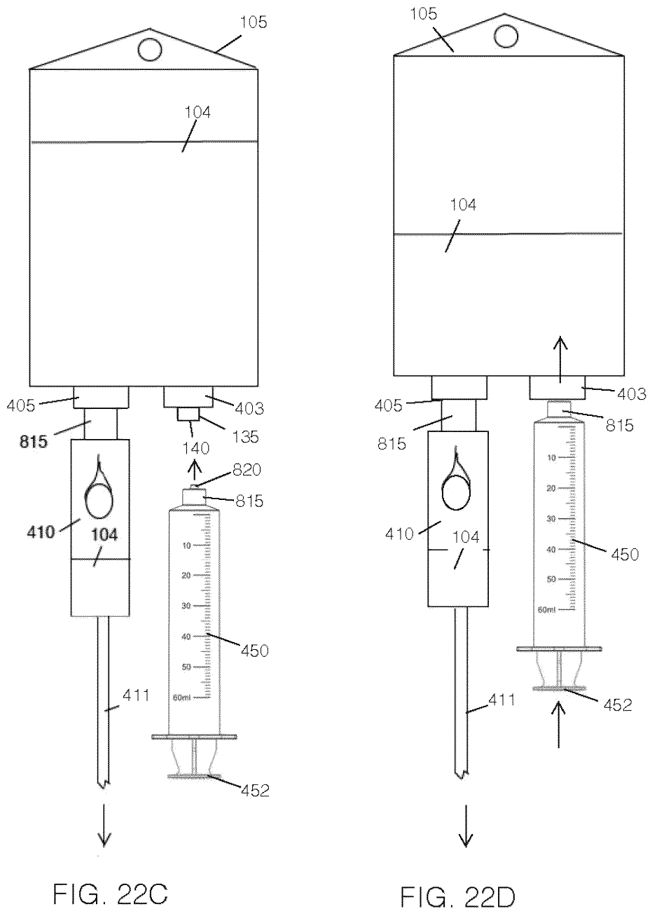

FIG. 21A illustrates a perspective view, FIG. 21B illustrates a front view, and FIG. 21C illustrates a side view of a syringe 450 for injecting fluids into the fluid reservoir IV bag. As discussed above with reference to FIGS. 18A and 18B the inlet port has a valve within an access member. The end of the syringe 450 can have a cylindrical connection portion 815 that can have female threads on the inner diameter and a hollow tip 820. The internal threads of the cylindrical connection portion 815 can be rotated to engage features on the access member of the inlet port on the IV bag so couple the syringe 450 to the inlet port. The threads can be right hand threads that tightens the coupling when the connection portion 815 is rotated clockwise relative to the IV bag and loosens the coupling when the connection portion 815 is rotated counterclockwise relative to the IV bag. Alternatively, the threads can be left-hand threads that loosens the coupling when the connection portion 815 is rotated clockwise relative to the IV bag and tightens the coupling when the connection portion 815 is rotated counterclockwise relative to the IV bag. The hollow tip 820 forms a seal with the end of the valve to prevent the fluid from leaking from the connection. The compression of the valve causes the slit to open. The plunger 452 can then be pressed into the syringe 450 so that a fluid in the syringe 450 such as liquid medicine can be injected into the IV bag. Once the proper dosage of fluid is injected, the syringe 450 can be rotated to release the syringe 450 to the inlet port. The valve can then be decompressed and the valve can expand to fill the interior volume of the connection portion 315. The decompression of the valve can cause the slit can close to a liquid tight seal to contain all fluids in the IV bag.

In some embodiments, the IV bag can be attached to an IV drip and IV fluids can flow from the IV bag into the IV drip. Additional fluids can be added to the IV bag with a syringe. FIGS. 20A-20D illustrate an embodiment of this process. FIG. 20A illustrates an embodiment of an IV fluid bag reservoir 105 filled with an IV fluid 104. An IV drip 410 can be moved into contact with the outlet port 405 of the IV fluid bag reservoir 105 and rotated to secure the access member 135 to the connection portion 815 of the IV drip 410 as shown in FIG. 20B. The tip 820 of the IV drip 410 can be pressed against the valve 140 of the outlet port 405 which can open the valve 140 and allow the IV fluid to flow into the IV drip 410 and into the IV line 411 exiting the IV drip 410.

It may be necessary to add fluids stored in a syringe 450 to the IV bag 105. FIG. 20C illustrates a syringe 450 that can be moved into contact with the inlet port 403 of the IV fluid bag reservoir 105. The syringe 450 can be rotated to secure the access cylindrical connection portion 815 to the access member 135 of the inlet port 403 as shown in FIG. 20D. The tip 820 of the syringe 450 can be pressed against the valve 140 of the inlet port 403 which can open the valve 140. The plunger 452 can be pressed into the syringe 450. The syringe 450 can then be unscrewed from the IV fluid bag reservoir 105 which can cause the valve 140 in the inlet port 403 to close. The liquids in the syringe 450 can flow into the IV bag 105 and mix with the IV fluids 105. The injected liquids can then flow through the IV drip 410 and IV line 411 to the patient.

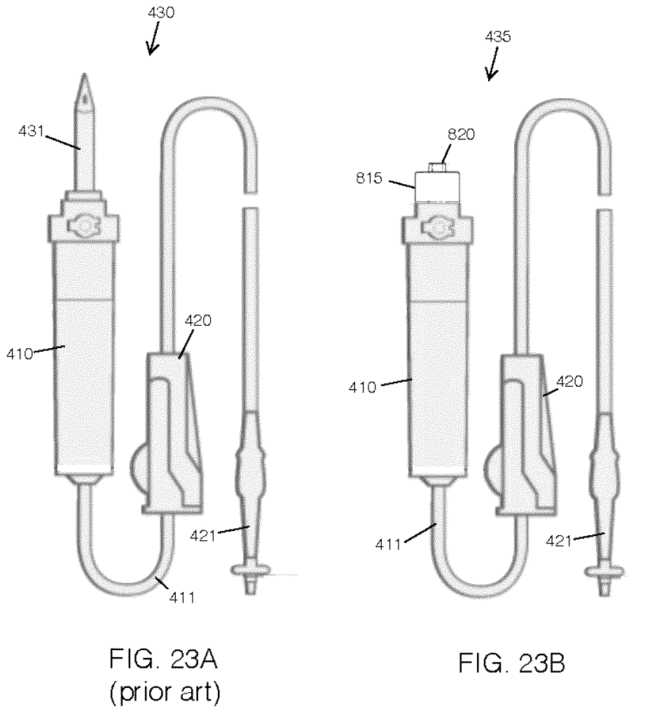

FIG. 23A illustrates an IV drip assembly 430 having an IV drip 410 with a hollow spike 431 end. The spike 431 can be made of a hard material and is inherently sharp enough to puncture a port seal on the IV bag. The sharp point of the spike 431 can be inherently dangerous to medical professionals who must hold the fluid connection port with one hand while driving the spike through the port seal with the other hand. During this procedure, the spike can very easily slip and possibly injure the medical professional leading to cuts, punctures, and contamination of the IV fluids. Another problem is that the spike may only be held in place by the friction between the punctured port material and the sides of the spike 431. If the IV line is pulled the spike 431 can easily come lose from the fluid connection port of the IV bag.

FIG. 23B illustrates an IV drip assembly 435 having an IV drip 410 with a spikeless connection that has smooth a cylindrical connection end portion 815 that can have female threads on the inner diameter and a smooth hollow tip 820. The lack of any sharp components can substantially improve safety and the threaded connection can prevent any unintended disconnection of the IV drip 410 from the outlet port of the IV bag. The outlet end of the IV drip 410 can be coupled to an IV line 460, a roller clamp 420 that can regulate the rate of IV infusion, and a connection 421 such as a Luer lock.

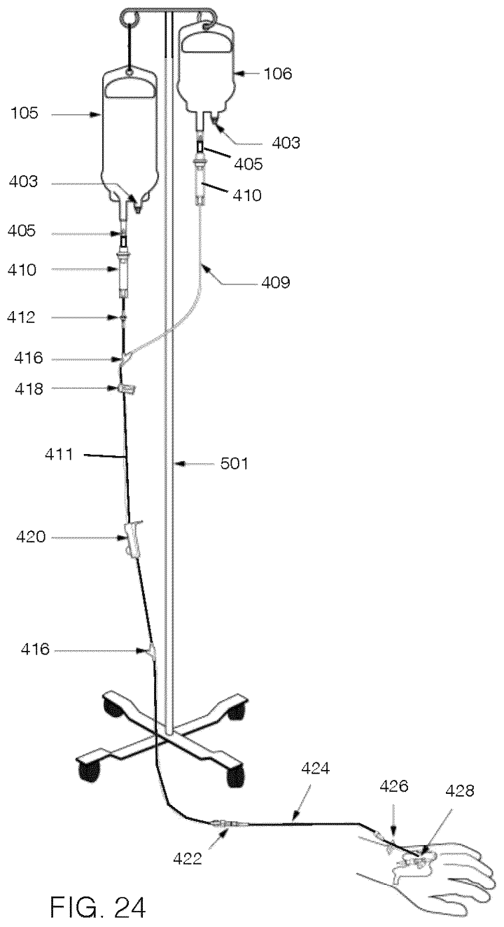

FIG. 24 illustrates another embodiment of an IV bag and line assembly. In this embodiment, an IV pole 501 supports a primary IV bag reservoir 105 and a secondary IV bag reservoir 105 which both have an inlet injection port 403 and an outlet port 405. The IV bags 105 can hung be in upright positions with injection ports 403 and outlet ports 405 on a lower end of the IV bag reservoir 105. The IV drip chamber 410 can be made of a transparent material so that the flow rate can be viewed and the flow rate of an IV fluid in drops/minute can be detected and measured.

The spikeless connection portion of the IV drip 410 can be coupled to the connection portion 815 of the outlet port 405. The hollow tip of the IV drip 410 connection compresses a valve in the outlet port 405 which causes the valve to open. The outlets of the drip chamber 410 can be coupled to an IV line 411 that can be coupled to a back check valve 412 that can prevent any reversed flow up the IV line 411. The IV line 411 can then be coupled to a junction port 416 that can be coupled to a secondary IV line 409 so that fluids from the secondary IV bag 106 can be mixed with the primary IV bag fluids.

The IV fluids can flow through the IV lines 411 that can pass through an slider clamp 418 and/or a roller clamp 420 that can compress the IV line 411 and adjust the flow rate of the IV fluids into the patient. A Luer lock coupling 422 can be attached to the end of the IV line 411 to connect the IV line 411 to an extension tubing 424. The extension tubing can be coupled to a clamp 426 and a cannula 428 that can be inserted into a blood vessel of the patient.

In the illustrated embodiments, the IV fluid bag receptacles have ports that include the valve within an access member while the IV drip and/or syringe can have cylindrical connection portions that surround hollow tips. This configuration can be beneficial because the valve can close when the IV drip and syringe are removed and the IV fluids will remain in the IV fluid bag receptacle. In other embodiments, the orientations of the connectors can be reversed with the IV drip and syringe having the valves within access members and the IV fluid bag receptacles can have ports with cylindrical connection portions that surround hollow tips. In yet other embodiments, the cylindrical connection portions that surround hollow tips can have one port with a valve within an access member and a second port with a cylindrical connection portion that surrounds a hollow tip.

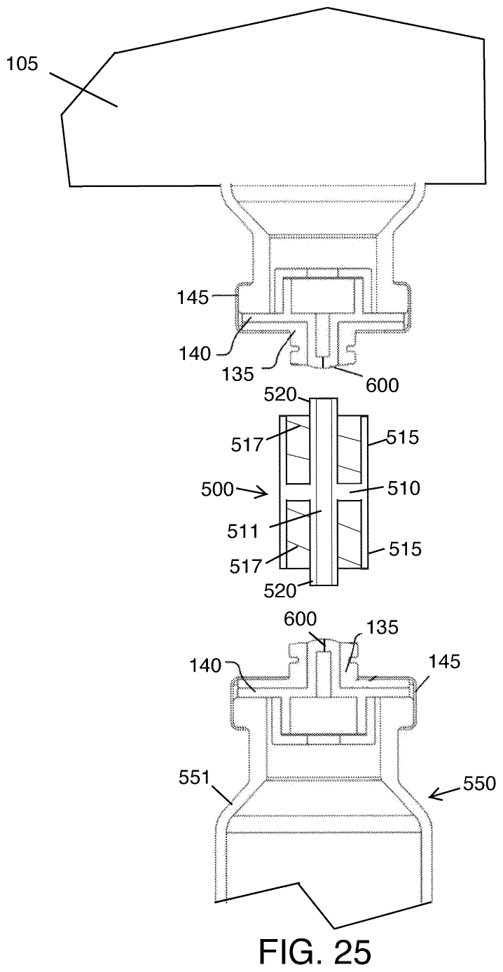

In some situations, it can be desirable to connect a fluid container having a female coupling to another female coupling input port on an IV bag. In order to accomplish this, a male to male adapter coupling can be used to connect a fluid container having a female coupling to a female coupling on an input port of an IV bag. FIG. 25 illustrates a cross section view of a female coupling of a fluid container 550, a male to male adapter coupling 500, and a female coupling on an input port of an IV bag 105.

The male to male adapter coupling 500 can have a hollow cylindrical structure and connection portions 515 on opposite ends that each have internal threads 517 on inner cylindrical surfaces of the connection portions 515. A center wall 510 can extend across the width of the adapter coupling 500 and the center wall 510 can be substantially perpendicular to the center axis of the adapter coupling 500. A hollow center tube 511 can be parallel and concentric to a center axis of the adapter coupling 500. The tips 520 on opposite ends of the center tube 511 can extend beyond the edges of the connection portions 515. The adapter coupling 500 can be made of a rigid plastic material or any other suitable material. The male to male adapter coupling 500 can be made of a transparent or a translucent material so that a user can see liquids flowing through the center tube 511 of the adapter coupling 500.

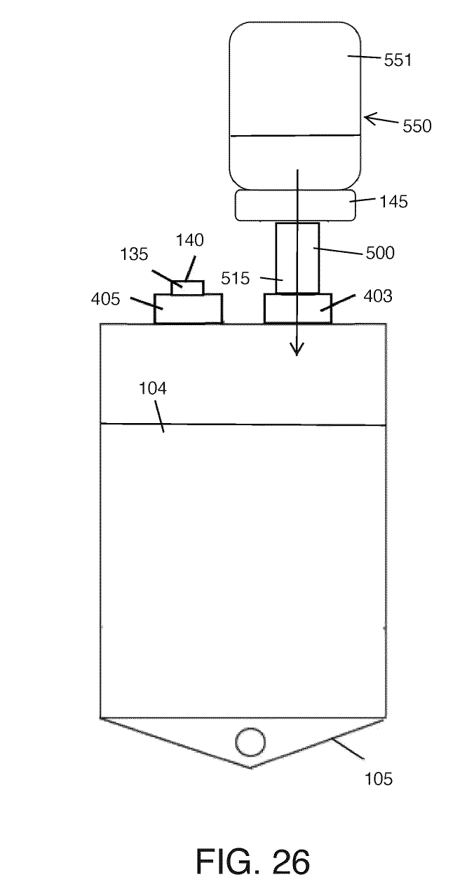

With reference to FIGS. 25 and 26, to use the adapter coupling 500, the tip 520 of the center tube 511 can be aligned around the slit 600 of the valve member 140 of the IV bag 105. The male threads on the outer diameter portion of the access member 135 can engage with the female threads 517 on the inner diameter of the connection portions 515 of the adapter coupling 500. Rotating the adapter coupling 500 relative to the IV bag 105 can cause the male threads on the access member 135 to engage with the female threads 517 on the adapter coupling 500 which presses the tip 520 of the center tube 511 against the slit 600 of the valve member 140. The slit 600 of the valve member 140 is normally closed and prevents liquids from flowing into or out of the IV bag 105. When the tip 520 of the center tube 511 is pressed against the slit 600 of the valve member 140, the slit 600 portion of the into the valve member 140 is pressed into the access member 135 and the deformation of the valve member 140 opens the slit 600 so that liquids can flow through the valve member 140. The adapter coupling 500 can be positioned above the IV bag 105, so that IV liquids in the IV bag 105 do not flow out of the IV bag 105.

The fluid container 550 can then be attached to the IV bag 105. The unused tip 520 of the center tube 511 can be aligned around the slit 600 of the valve member 140 of the fluid container 550. The male threads on the outer diameter portion of the access member 135 can engage with the female threads 517 on the inner diameter of the connection portions 515 of the adapter coupling 500. Rotating the adapter coupling 500 relative to the fluid container 550 can cause the male threads on the access member 135 to engage with the female threads 517 on the adapter coupling 500 which presses the tip 520 of the center tube 511 against the slit 600 and opens the valve member 140. With the valve opened, the fluid container 550 can raised above the adapter coupling 500 and the IV bag 105 so that liquids in the fluid container 550 can flow into the IV bag 105 and mix with the IV fluids.

Once the desired quantity of liquids have passed from the fluid container 550 to the IV bag 105, the adapter coupling 500 can be disconnected from the IV bag 105 and the fluid container 550. The valve members 140 can return to their normal positions in the access members 135 and the slits 600 can close to prevent liquids from passing through the valve members 140. The IV bag 105 can be rotated into a normal position as shown in FIG. 24 and used to supply IV fluids to a patient.

The present disclosure, in various embodiments, includes components, methods, processes, systems, and/or apparatus substantially as depicted and described herein, including various embodiments, subcombinations, and subsets thereof. Those of skill in the art will understand how to make and use the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease, and/or reducing cost of implementation. Rather, as the following claims reflect, inventive aspects lie in less than all features of any single foregoing disclosed embodiment.

What is claimed is:

1. A fluid coupling assembly, comprising:
an intravenous (IV) fluid reservoir containing IV liquid contents;
an access member coupled to the IV fluid reservoir, the access member having a first section and a second section, the first section includes a connection portion surrounding a first hollow portion and a first opening, the second section having a second hollow portion and a second opening in fluid communication with the liquid contents in the IV fluid reservoir;
a valve member within the access member that extends from the first hollow portion to the second hollow portion of the access member; and
an extraction device that is attachable to the connection portion of the access member;
wherein when the extraction device is connected to the connection portion, the valve member opens and provides access to the liquid contents of the IV fluid reservoir through the first opening and when the extraction device is disconnected from the to the connection portion, the valve member seals the IV liquid contents in the IV fluid reservoir at the first opening.

2. The fluid coupling assembly of claim 1, further comprising:
a slit in the valve member wherein the slit is in the first hollow portion of the access member, wherein the slit is closed when the valve member in an uncompressed state and the slit opens when the valve member in a compressed state.

3. The fluid coupling assembly of claim 1, wherein the extraction device includes a hollow tip that compresses the valve when the extraction device is connected to the connection portion and forms a seal with the valve when the extraction device is connected to the connection portion.

4. The fluid coupling assembly of claim 1, wherein valve has a first cylindrical portion and a second cylindrical portion and the outer of the diameter of the first cylindrical portion is larger than the outer of the diameter of the second cylindrical portion.

5. The fluid coupling assembly of claim 1, wherein valve has a first cylindrical portion and a second cylindrical portion and the inner of the diameter of the first cylindrical portion is larger than the inner of the diameter of the second cylindrical portion.

6. The fluid coupling assembly of claim 1, further comprising:
an IV line coupled to the extraction device;
a cannula coupled to an end of the IV line; and
a fluid control component coupled to the IV line selected from the group consisting of a drip chamber, a roller clamp, a slide clamp, a check valve, and a Y injection port;
wherein the connection coupled to the IV line does not include a spike or a syringe needle.

7. The fluid coupling assembly of claim 1, further comprising:
a port access member coupled to the IV fluid bag;
a port valve member within the port access member, and
an injection device that is attachable to the port access member;
wherein when the injection device is connected to the port access member, the port valve member opens and provides access to the IV solution in the IV fluid bag and when the injection device is disconnected from the port access member, the port valve member seals the IV solution in the IV fluid bag and the injection device does not include a spike or a syringe needle.

8. An intravenous (IV) line assembly, comprising:
an IV fluid bag containing an IV solution;
an access member coupled to the IV fluid bag, the access member having a first section and a second section, the first section includes a connection portion surrounding a first hollow portion and a first opening, the second section having a second hollow portion and a second opening in fluid communication with the liquid contents in the IV fluid bag;
a valve member within the access member in the first hollow portion and the second hollow portion of the access member; and
a drip chamber connected to a coupling that is attachable to the connection portion of the access member;
wherein when the coupling is connected to the connection portion, the valve member opens and provides access to the IV solution in the IV fluid bag through the first opening and when the extraction device is disconnected from the to the connection portion, the valve member seals the IV solution in the IV fluid bag at the first opening.

9. The intravenous (IV) line assembly of claim 8, further comprising:
a slit in the valve member wherein the slit is in the first hollow portion of the access member, wherein the slit is closed when the valve member in an uncompressed state and the slit opens when the valve member in a compressed state.

10. The intravenous (IV) line assembly of claim 8, wherein the coupling includes a hollow tip that compresses the valve when the coupling is connected to the connection portion and forms a seal with the valve when the coupling is connected to the connection portion.

11. The intravenous (IV) line assembly of claim 8, wherein the width of the second hollow portion is wider than the width of the second opening, the valve has a first cylindrical portion and a second cylindrical portion, and the outer of the diameter of the first cylindrical portion is larger than the outer of the diameter of the second cylindrical portion.

12. The intravenous (IV) line assembly of claim 8, wherein valve has a first cylindrical portion and a second cylindrical portion and the inner of the diameter of the first cylindrical portion is larger than the inner of the diameter of the second cylindrical portion and the inner of the diameter of the first cylindrical portion is larger than the inner of the diameter of the second opening.

13. The intravenous (IV) line assembly of claim 8, further comprising:
an IV line coupled to the drip chamber;
a cannula coupled to an end of the IV line; and
a fluid control component coupled to the IV line selected from the group consisting of a drip chamber, a roller clamp, a slide clamp, a check valve, and a Y injection port;
wherein the connection coupled to the IV line does not include a spike or a syringe needle.

14. The fluid coupling assembly of claim 8, further comprising:
a port access member coupled to the IV fluid bag;
a port valve member within the port access member, and an injection device that is attachable to the port access member;
wherein when the injection device is connected to the port access member, the port valve member opens and provides access to the IV solution in the IV fluid bag and when the injection device is disconnected from the port access member, the port valve member seals the IV solution in the IV fluid bag and the injection device does not include a spike or a syringe needle.

15. A fluid coupling assembly, comprising:
a fluid reservoir containing liquid contents;
an access member coupled to the fluid reservoir, the access member having a first hollow portion and a second hollow portion;
a valve member within the access member that extends from the first hollow portion to the second hollow portion of the access member; and
an extraction device that is attachable to the connection portion of the access member;
wherein when the extraction device is connected to the connection portion, the valve member opens and provides access to the liquid contents of the fluid reservoir and when the extraction device is disconnected from the connection portion, the valve member closes and seals the liquid contents in the fluid reservoir.

16. The fluid coupling assembly of claim 15, further comprising:
a slit in the valve member wherein the slit is in the first hollow portion of the access member, wherein the slit is closed when the valve member in an uncompressed state and the slit opens when the valve member in a compressed state.

17. The fluid coupling assembly of claim 15, wherein the extraction device includes a hollow tip that compresses the valve when the extraction device is connected to the connection portion and forms a seal with the valve when the extraction device is connected to the connection portion.

18. The fluid coupling assembly of claim 15, wherein valve has a first cylindrical portion and a second cylindrical portion and the outer of the diameter of the first cylindrical portion is larger than the outer of the diameter of the second cylindrical portion.

19. The fluid coupling assembly of claim 15, wherein valve has a first cylindrical portion and a second cylindrical portion and the inner of the diameter of the first cylindrical portion is larger than the inner of the diameter of the second cylindrical portion.

20. The fluid coupling assembly of claim 15, further comprising:
a fluid line coupled to the extraction device;
a cannula coupled to an end of the fluid line; and
a fluid control component coupled to the fluid line selected from the group consisting of a drip chamber, a roller clamp, a slide clamp, a check valve, and a Y injection port;
wherein the connection coupled to the fluid line does not include a spike or a syringe needle.
